(19) United States
(12) Patent Application Publication
(10) Pub. No.: US 2026/0231084 A1
(43) Pub. Date: Aug. 6, 2026

(54) USER EQUIPMENT CONFIGURED FOR PERFORMING SIDELINK POSITIONING MEASUREMENTS IN 5G NR NETWORKS

(71) Applicant: Intel Corporation, Santa Clara, CA (US)

(72) Inventors: Rui Huang, Beijing (CN); Meng Zhang, Beijing (CN); Andrey Chervyakov, Maynooth (IE); Hua Li, Beijing 11 (CN); In-Seok Hwang, Santa Clara, CA (US)

(21) Appl. No.: 19/149,008

(22) PCT Filed: Feb. 16, 2024
(86) PCT No.: PCT/US2024/016115

§ 371 Date: Jul. 17, 2025

Related U.S. Application Data
(60) Provisional application No. 63/485,719, filed on Feb. 17, 2023.

(51) Int. Cl. H04W 64/00; H04W 92/18

(52) U.S. Cl. CPC H04W 64/00; H04W 92/18

(57) ABSTRACT

The present disclosure is related to user equipment (UE) behaviors and requirements for sidelink positioning. A target UE receives a sidelink positioning protocol (SLPP) request to measure and report sidelink (SL) positioning measurements. The target UE measures a set of SL positioning reference signals (PRSs) based on the received request, and transmits a measurement report. The measurement report includes positioning results based on the measurement of the set of SL PRSs. Other embodiments may be described and/or claimed.

### CROSS REFERENCE TO RELATED APPLICATIONS

The present application claims priority to U.S. Provisional App. 63/485,719 filed Feb. 17, 2023 (“'719”), the contents of which is hereby incorporated by reference in its entirety.

### BACKGROUND

3GPP fifth generation (5G)/new radio (NR) technologies, such as operation in low and high frequency bands (e.g., below and above 6 gigahertz (GHz)) and utilization of massive antenna arrays, can provide enhanced location capabilities and improvements in positioning accuracy. To this end, sidelink (SL) reference signal and measurement procedures for SL positioning and ranging (SLPR) in NR systems are currently being designed. However, measurement reporting requirements for SL positioning and/or ranging methods have not been specified or otherwise defined.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings in which:

FIG. 1 illustrates an example PC5-only network scenario;

FIG. 2 illustrates an example PC5-Uu network scenario;

FIG. 3 illustrates an example of ranging between user equipment (UEs) with or without fifth generation (5G) coverage;

FIG. 4 depicts an example network architecture;

FIG. 5 depicts an example UE positioning architecture;

FIG. 6 depicts an example network assisted sidelink positioning architecture and an example location services reference architecture;

FIG. 7 depicts an example reference architecture for SLPR-based services;

FIG. 8 depicts an example wireless network;

FIG. 9 depicts example hardware resources; and

FIGS. 10 and 11 depict example processes for practicing the various embodiments discussed herein.

### DETAILED DESCRIPTION

### 1. Sidelink Positioning Aspects

The present disclosure is generally related to wireless communications technologies, network topologies, and communication device implementations, and in particular, to user equipment (UE) behavior and requirements for sidelink (SL) positioning and/or ranging.

In Release (Rel-)17, 3GPP RAN conducted studies on “NR Positioning Enhancements” in 3GPP TR 38.857 (“[TR38857]”)) and “Scenarios and requirements of in-coverage, partial coverage, and out-of-coverage NR positioning use cases” (see 3GPP TR 38.845 (“[TR38845]”)), which focused on vehicle-to-everything (V2X) and public safety use cases. Additionally, system architecture working group 1 (SA1) has developed requirements in 3GPP TS 22.261 (“[TS22261]”) for ranging based services and has developed positioning accuracy requirements in 3GPP TS 22.104 (“[TS22104]”) for industrial IoT (IIoT) use cases in out-of-coverage scenarios.

Positioning integrity is a measure of the trust in the accuracy of the position-related data and the ability to provide timely warnings based on assistance data provided by the network (NW). The focus during Rel-17 work was on GNSS integrity, and for Rel-18 it is natural to extend this to address other positioning techniques as well as there are relevant integrity aspects of mission critical use cases that rely on positioning estimates and the corresponding uncertainty estimate. Integrity enables applications to make the correct decisions based on the reported position, e.g., when monitoring a robotic arm to decide whether its arm movement are within allowed limits to ensure safety distances to humans and other objects.

Regarding higher accuracy, two additional techniques have been considered in Rel-18: one is to take advantage of the rich 5G spectrum to increase the bandwidth for the transmission and reception of the positioning reference signals based on PRS/SRS bandwidth aggregation for intra-band contiguous carriers, and the other is to use the NR carrier phase measurements. GNSS carrier phase positioning has been used very successfully for centimetre-level positioning accuracy but is limited to outdoor applications.

Requirements have been introduced for Low Power High Accuracy Positioning (LPHAP) for industrial IoT scenarios including use cases such as massive asset tracking, automatic guided vehicle (AGV) tracking in industrial factory, and person localization in danger zones. These requirements are for high accuracy and extremely low power consumption with battery life sustainable up to one or more years. A typical scenario of interest is use case #6 as defined [TS22104], which corresponds to tracking of workpiece (in-door and outdoor) in assembly area and warehouse with a target accuracy of <1m, a positioning interval of 15-30 seconds, and a battery life of 6-12 months. While Rel-17 NR positioning has introduced support for positioning in RRC_INACTIVE state, whether the current system allows LPHAP requirements to be met was not evaluated during Rel-17.

Rel-17 has specified support for reduced capability (RedCap) UEs 402 with reduced bandwidth support and reduced complexity including a reduced number of receive (Rx) chains. A RedCap UE 402 is a UE 402 with reduced capabilities as defined in 3GPP TS 38.306 § 4.2. Such UEs 402 could support NR positioning functionality, but there is a gap in that the core and performance requirements have not been specified for the positioning related measurements performed by RedCap UEs 402, and no evaluation was performed to see how the reduced capabilities of RedCap UEs 402 might impact eventual position accuracy.

Towards determination of the scenarios and requirements, bandwidth requirements, and solutions for support of SL ranging/positioning, enabling improved integrity, accuracy, and power efficiency for NR positioning solutions, and evaluation of positioning performance for RedCap UEs 402, a Rel-18 Study Item on “Study on Expanded and Improved NR Positioning” has been carried out by 3GPP, which is documented in 3GPP TR 38.859 (“[TS38859]”).

Based on the study, various features and enhancements have been recommended for normative work for support of SL ranging/positioning, support of integrity for RAT-dependent positioning methods, enhancements to enable LPHAP use-cases defined in [TS22104], and support of positioning for RedCap UEs 402 with acceptable positioning accuracy considering requirements for IIoT, commercial, public safety, and V2X use cases.

Based on the study, PRS/SRS bandwidth aggregation for intra-band contiguous carriers is concluded as feasible for single chain Tx/Rx architectures at both the UE 402 and RAN node 414 (e.g., gNB 414a). Another technique is the NR carrier phase positioning, which has the potential for significant performance improvements for indoor and outdoor deployments in comparison with the existing NR positioning methods, as well as shorter latency and lower UE power consumption in comparison with RTK-GNSS outdoors. Based on the study, it is concluded that it is feasible to use existing DL PRS and SRS signals to obtain the carrier phase measurements for achieving a horizontal accuracy of up to a few centimetres at least at 50% under certain conditions.

An objective of the 3GPP Work Item Description (WID), New WID on Expanded and Improved NR Positioning, 3GPP TSG RAN Meeting #98-e, Agenda Item 9.1.1, RP-223532 (12-16 Dec. 2022) (“RP-223532”) is to specify solutions to support of SL positioning and ranging (SLPR) in NR systems. From physical layer perspective, the new measurement reference signal and procedures for SLPR may be designed and standardized. For an example, the measurement reporting requirements for the different positioning methods (e.g., SL-round trip time (RTT), SL-angle of arrival (AoA), and SL-time difference of arrival (TDoA), and/or other SLPR measurements) with the new SL-positioning reference signal (PRS) measurement should be specified in Rel-18.

The requirements for RTT and TDoA with the new SL-PRS measurements need to be specified in Rel-18. Since the requirements for AoA beyond Rel-17 are absent, whether SL-AoA should be defined in Rel-18 can be for future study (FFS). Based on these observations, a first embodiment involves defining requirements for RTT and TDoA for SL positioning, and defining other positioning methods (e.g., SL-AoA, and the like) are FFS.

Also, as explicitly noted in RP-223532, SL-PRS transmission is supported up to 100 MHz in frequency range 1 (FR1) spectrum but not in frequency range 2 (FR2). In some implementations, SL-PRS in FR2 does not need to be considered. In some implementations, the requirements for SL positioning measurements are defined in FR1 only.

Moreover, reporting signaling and procedures to facilitate support of SL positioning in some or all coverage scenarios and for PC5-only and joint PC5-Uu scenarios (see e.g., RP-223532) are considered. For an example, UE measurement configuration and reporting in case of PC5 SL can be based on a new SL positioning protocol (SLPP) protocol. But from the physical layer measurements themselves, UE's behaviour itself could be unchanged in comparison with these with Uu link.

In some examples, the requirements for SL positioning in case of PC5-only can be decoupled from joint PC5-Uu scenario. In order to simplify RAN4's work on SL requirements for all coverage scenarios (PC-only and joint PC5-Uu link), In some implementations, the requirements for SL positioning can be started from these for PC5-only scenario firstly.

For the new procedure of power control for SL-PRS transmission, whether the existing power headroom report mapping is feasible should be considered. In some implementations, the report mapping for the power control of SL-PRS can be FFS. In some examples, a relatively small resolution of this mapping table can be determined/generated.

According to various embodiments, UE behavior and requirements are provided for when a UE performs positioning measurements in SL. In some embodiments, the positioning measurements can be for RTT and TDoA with new SL-PRS. Additionally or alternatively, the requirements can be defined for both PC5-only and PC5-Uu joint scenarios. Additionally or alternatively, the requirements for PC5-Uu joint scenario can be defined based on PC5-only and Uu-only. Additionally or alternatively, the report mapping for the power control of SL-PRS can be defined.

In some embodiments, NR measurement for SL positioning includes requirements for RTT and TDoA with the new SL-PRS measurements is defined herein.

In some embodiments, NR measurement for SL positioning includes requirements for SL positioning in case of joint PC5-Uu scenario can be defined based on PC5-only and Uu-only.

In some embodiments, NR measurement for SL positioning includes a report mapping for the power control of SL-PRS can be defined with smaller resolution than the general power control procedure.

In some embodiments, NR measurement for SL positioning includes a report mapping for the measured timing differences between reference signals. In these embodiments, SL positioning can make use of configured finer grained resolution for measurement results reporting.

In some implementations, the reporting range of the various report mappings is defined from −985024T_{c} to +985024×T_{c} (see e.g., [TS38215]). Additionally or alternatively, the reporting resolution is uniform across the reporting range and is defined as T=T_{c}*2^{k} where k is selected by the gNB 414 and/or a UE 402 from the set {0, 1, 2, 3, 4, 5}, where T_{c} is defined in [TS38211].

### 1.1. Positioning Performance Requirements

High accuracy positioning is becoming essential for Factories of the Future, as well as other applications and/or use cases. The reason for this is that tracking of mobile devices as well as mobile assets is becoming increasingly important in improving processes and increasing flexibility in industrial environments.

The 5GS provides positioning information for a UE that is out of coverage of the network, with accuracy of <[1 m] relative to other UEs that are in proximity and in coverage of the network.

Table 1.1-1 lists example scenarios and the corresponding high positioning requirements for horizontal and vertical accuracy, availability, heading, latency, and UE speed (see also table 5.7.1-1 in [TS22104]).

TABLE 1.1-1
Positioning Performance Requirements

| | | | | | | | Latency for | | | |
|---|---|---|---|---|---|---|---|---|---|---|
| | | | | | | | position | | | Corresponding |
| | Horizontal | | Vertical | | | | estimation | | UE | Positioning |
| Scenario | accuracy | | accuracy | | Availability | Heading | of UE | | speed | Service Level |
| Mobile control panels | <5 | m | <3 | m | 90% | n/a | <5 | s | n/a | Service |
| with safety functions | | | | | | | | | | Level 2 |
| (non-danger zones) | | | | | | | | | | |
| Process automation - | <1 | m | <3 | m | 90% | n/a | <2 | s | <30 | Service |
| plant asset management | | | | | | | | | km/h | Level 3 |
| Flexible, modular | <1 m | | n/a | | 99% | n/a | 1 | s | <30 | Service |
| assembly area in smart | (relative | | | | | | | | km/h | Level 3 |
| factories (for tracking of | positioning) | | | | | | | | | |
| tools at the work-place | | | | | | | | | | |
| location) | | | | | | | | | | |
| Augmented reality in | <1 | m | <3 | m | 99% | <0.17 | <15 | ms | <10 | Service |
| smart factories | | | | | | rad | | | km/h | Level 4 |
| Mobile control panels | <1 | m | <3 | m | 99.9% | <0.54 | <1 | s | n/a | Service |
| with safety functions in | | | | | | rad | | | | Level 4 |
| smart factories (within | | | | | | | | | | |
| factory danger zones) | | | | | | | | | | |
| Flexible, modular | <50 | cm | <3 | m | 99% | n/a | 1 | s | <30 | Service |
| assembly area in smart | | | | | | | | | km/h | Level 5 |
| factories (for | | | | | | | | | | |
| autonomous vehicles, | | | | | | | | | | |
| only for monitoring | | | | | | | | | | |
| purposes) | | | | | | | | | | |
| Inbound logistics for | <30 cm (if | | <3 | m | 99.9% | n/a | 10 | ms | <30 | Service |
| manufacturing (for | supported | | | | | | | | km/h | Level 6 |
| driving trajectories (if | by further | | | | | | | | | |
| supported by further | sensors like | | | | | | | | | |
| sensors like camera, | camera, | | | | | | | | | |
| GNSS, IMU) of indoor | GNSS, | | | | | | | | | |
| autonomous driving | IMU) | | | | | | | | | |
| systems)) | | | | | | | | | | |
| Inbound logistics for | <20 | cm | <20 | cm | 99% | n/a | <1 | s | <30 | Service |

| | | |
|---|---|---|
| manufacturing (for | km/h | Level 7 |
| storage of goods) | | |

The column on “Corresponding Positioning Service Level” maps the scenarios listed in table 1.1-1 to service levels discussed herein and/or in [TS22261].

### 1.2. Nr Sidelink Measurements for Positioning

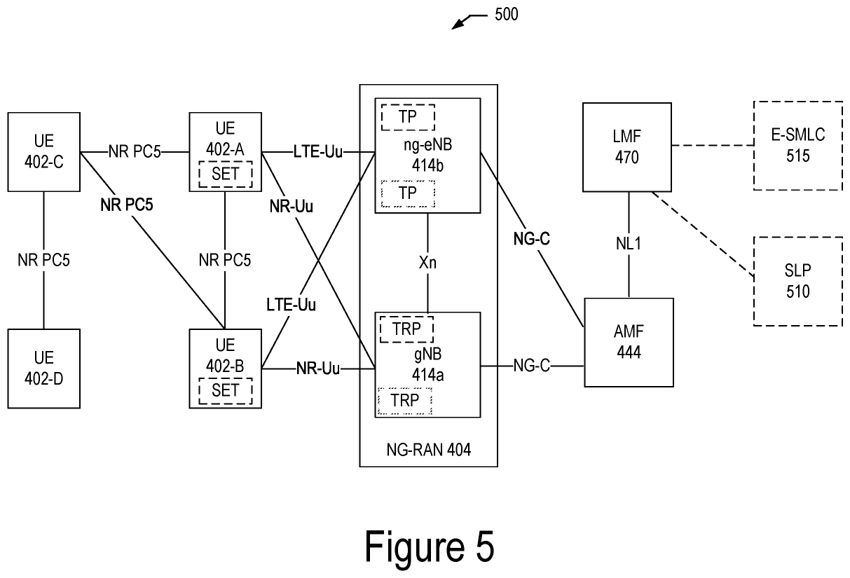

In various implementations, the measurement requirements for NR SL positioning are applicable to UEs 402 capable of V2X and/or 5G proximity services (ProSe) operation, which is also capable of performing SL positioning measurements defined herein and/or in [TS38215], including SL-RSTD, SL PRS-RSRP, SL Rx-Tx time difference, SL PRS-RSRPP measurements, SL-AoA, and SL-RTOA, provided that the SL-PRS are received on NR PC5 interface (see e.g., FIGS. 5, 6, and 7) within a single SL BWP on a single carrier, the UE 402 is in any cell selection state or the UE 402 is inside NG-RAN coverage while configured for SL positioning operation on a SL carrier, which is dedicated to only SL operation, and configured with only a PCell on WAN carrier, and/or the UE 402 is not required to monitor PSCCH, which is associated with SL-PRS in the same slot, outside the SL-DRX active time.

In some examples, any cell selection state refers to a UE 402 that is out of network coverage and is not associated with a serving cell on any carrier as defined in [TS38304]. Additionally or alternatively, when a UE 402 is in the RRC_CONNECTED state is performing transmissions and/or reception for SL positioning operation, the UE 402 meets all the requirements specified in [TS38133] § 9 assuming that the UE 402 has a dedicated Rx/Tx chain for the SL operation. Otherwise, the UE 402 may interrupt the SL positioning measurements in order to meet the measurement requirements specified in [TS38133] § 9. Additionally or alternatively, prior to performing SL-PRS based measurements, the UE 402 may need to perform the discovery procedure.

### 1.2.1. SL-RSTD Measurements

The requirements for SL-RSTD measurements apply provided the UE 402 has received an SLPP-RequestLocationInformation message (or a CommonIEsRequestLocationInformation message, CommonSL-PRS-MethodsIEsRequestLocationInformation message, SL-TDOA-RequestLocationInformation message, SL-TOA-RequestLocationInformation message, SL-RTT-RequestLocationInformation message, and/or the like) from an LMF 470 or another UE 402 via SLPP (see e.g., [TS38355]) requesting the UE 402 to measure and report SL RSTD measurements defined in [TS38215] based on SL-PRS.

An SL RSTD measurement is the SL relative timing difference between the UE j and the reference UE i, defined as T_{SL-RXi}−T_{SL-RXj}, where: T_{SL-RXj} is the time when the UE (e.g., target UE 402t) receives the start of one subframe from UE j; and T_{SL-RXi} is the time when the UE (e.g., target UE 402t) receives the corresponding start of one subframe from UE i that is closest in time to the subframe received from UE j. For FR1, the reference point for SL RSTD measurement is the Rx antenna connector of the UE 402. For FR2, the reference point for SL RSTD measurement is the Rx antenna of the UE 402. SL RSTD measurements are applicable for UEs 402 in RRC_CONNECTED and/or RRC_IDLE.

The requirements for SL-RSTD measurements apply for periodic, aperiodic, and triggered RSTD measurements, provided that the SL RSTD related side conditions for FR1 are fulfilled for a corresponding band.

The UE SL-RSTD measurement capability is as indicated by the UE 402 in sl-TDOA-ProvideCapabilities according to 3GPP TS 38.355 (“[TS38355]”). The IE SL-TDOA-ProvideCapabilities is used to indicate the support of SL-TDOA and to provide SL-TDOA positioning capabilities. The SL-TDOA-ProvideCapabilities IE includes an application layer ID IE/field (applicationLayerID); a positioning modes IE/field (positioningModes) that specifies the SL-TDOA mode(s) supported by the UE; a periodical reporting IE/field (periodicalReporting) that, if present, specifies the positioning modes for which the UE supports periodicalReporting; and an ‘ten milliseconds’ IE/field (tenMsUnitResponseTime) that if present, specifies the positioning modes for which the UE supports the enumerated value ‘ten-milli-seconds’ in the IE ResponseTime in IE CommonIEsRequestLocationInformation.

The measurement reporting delay is defined as the time between the moment when the measurement report is triggered and the moment when the UE 402 starts to transmit the measurement report over the air interface.

For a UE 402 reporting to the LMF 470, this measurement reporting requirement assumes that the measurement report is not delayed by other SLPP signalling on the DCCH. This measurement reporting delay excludes a delay uncertainty resulted when inserting the measurement report to the TTI of the uplink DCCH. The delay uncertainty is: 2×TTIDCCH where TTIDCCH is the duration of subframe or slot or subslot when the measurement report is transmitted on the PSSCH with subframe or slot or subslot duration.

For a UE 402 reporting to another UE 402, this measurement reporting requirement assumes that the measurement report is not delayed by other SLPP signalling on the STCH. This measurement reporting delay excludes a delay uncertainty resulted when inserting the measurement report to the TTI of the transmitted STCH. The delay uncertainty is: 2×TTISTCH where TTISTCH is the duration of subframe or slot or subslot when the measurement report is transmitted on the PSSCH with subframe or slot or subslot duration.

The measurement reporting delay excludes any delay caused by no SL resources and/or SL-PRS resources for the UE 402 to send the measurement report.

The reported SL RSTD measurement values contained in measurement reports are based on the measurement report mapping requirements, which may be predefined, configured, and/or implementation-specific. In one example, the measurement report mapping requirements include a reporting range is defined from −985024T_{c} to +985024×T_{c}, and a reporting resolution that is uniform across the reporting range and defined as T=T_{c}*2^{k} where k is selected by a gNB 414a or UE 402 from the set {0, 1, 2, 3, 4, 5}, and wherein T_{c} is defined in [TS38211]. In this example, the LMF recommended resolution parameter, 470 provides a timing ReportingGranularityFactor, and the selected parameter k based on timingReportingGranularityFactor is indicated to the LMF LMF 470. Additionally or alternatively, the mapping of measured quantity for each reporting resolution (k) is defined in Tables 13.1.1-1 to 13.1.1-6 in [TS38133]. Additionally or alternatively, the measurement report mapping requirements include a reporting range of additional path reporting defined from −8175×T_{c} to +8175×T_{c}. The reporting resolution is uniform across the reporting range and is defined as T=T_{c}*2^{k} where k is selected by a gNB 414a or UE 402 from the set {0, 1, 2, 3, 4, 5}, and wherein T_{c} is defined in [TS38211]. In this example, the LMF 470 provides a recommended resolution parameter, timingReportingGranularityFactor, and the selected parameter k based on timingReportingGranularityFactor is indicated to the LMF LMF 470. Additionally or alternatively, the mapping of measured quantity for each reporting resolution (k) is defined in Tables 13.1.1A-1 to 13.1.1A-6 in [TS38133]. Additional or alternative measurement report mapping requirements can be used in other implementations.

The SL RSTD measurements performed and reported according to this section is to meet the SL RSTD measurement accuracy requirements, for each measured SL-PRS resource, which may be predefined, configured, and/or implementation-specific.

The measurement period requirements for SL-RSTD include, for example, when the physical layer receives last of an sl-TDOA-ProvideAssistanceData message and sl-TDOA-RequestLocationInformation message from the LMF 470 or another UE 402 via SLPP (see e.g., [TS38355]), the UE 402 is able to perform at least X SL RSTD measurements (where X is a number, which may be predefined, configured, and/or up to UE implementation), with each SL RSTD measurement including measurement on the measured target link and the reference link, defined in [TS38215], during the measurement period T_{SL RSTD,Total} defined as:

$${T}_{SL RSTD , Total} = {\sum }_{s = 1}^{S} {T}_{SL RSTD , effect , s}$$

where: S is the number of samples per measured link, wherein S=1 for SL-PRS BW>48 PRBs, and/or S=4 for 24 PRBs≤SSL-PRS BW≤48 PRBs; T_{dur,s} is the SL-PRS duration for SL-PRS sample s of the SL RSTD measurement; Δ_{SLproc} is the processing time, which may be predefined, configured, or implementation-specific; and T_{SL RSTD,effect,s} is defined as T_{SL RSTD,effect,s}=tₛ₊₁−tₛ, for s<S, provided that T_{SL RSTD,effect,s}≥T_{dur,s}+Δ_{SLproc}, where tₛ₊₁ and tₛ are the beginning of the first slot corresponding to the next and current SL-PRS samples, respectively, in which the UE is configured to receive SL-PRS for performing the SL-RSTD measurement, or T_{SL RSTD,effect,s}=T_{dur,s}+Δ_{SLproc}, for s=S.

In an example, the measured target link is an SL link and/or PC5 interface, and the reference link is the Uu link/interface. In these examples, the SL RSTD measurements may be used for joint PC5-Uu scenarios. In another example, the measured target link is an SL link and/or PC5 interface, and the reference link is another SL link and/or PC5 interface.

If the synchronization reference source changes during T . . . (e.g., during the measurement period) at the measuring UE 402, or at the UE 402 configured to transmit SL-PRS, for the target measured link or the reference link (see e.g., [TS38355]) for the SL RSTD measurement, while the UE 402 is performing the SL RSTD measurement, then the UE 402 restarts the SL RSTD measurement after the synchronization reference source change.

In some examples, if the synchronization reference source changes at the measuring UE 402 or at the UE 402 configured to transmit SL-PRS for the target measured link or the reference link (see e.g., [TS38355]) for the SL RSTD measurement, while the measuring UE 402 is performing the SL RSTD measurement, then the measuring UE 402 restarts the SL RSTD measurement and sends the measurement report no later than T_{SL RSTD,restart}=(K+1)*T_{SL RSTD,Total}, where K is the number of restarts due to the synchronization source changes.

### 1.2.2. SL-RSRP Measurements

The requirements for SL-RSRP measurements apply provided the UE 402 has received SLPP-RequestLocationInformation message (or a CommonIEsRequestLocationInformation message, CommonSL-PRS-MethodsIEsRequestLocationInformation message, SL-TDOA-RequestLocationInformation message, SL-TOA-RequestLocationInformation message, SL-RTT-RequestLocationInformation message, and/or the like) from the LMF 470 or another UE 402 via SLPP (see e.g., [TS38355]) requesting the UE 402 to measure and report SL PRS-RSRP measurements defined in [TS38215] based on SL-PRS.

SL PRS reference signal received power (SL PRS-RSRP) is defined as the linear average over the power contributions (in Watts (W)) of the resource elements that carry SL PRS reference signals configured for RSRP measurements within the considered measurement frequency bandwidth. For FR1, the reference point for the SL PRS-RSRP is the antenna connector of the UE 402. For FR1, if receiver diversity is in use by the UE 402, the reported SL PRS-RSRP value is not lower than the corresponding SL PRS-RSRP of any of the individual receiver branches. For FR2, SL PRS-RSRP is measured based on the combined signal from antenna elements corresponding to a given receiver branch. If receiver diversity is in use by the UE 402, the reported SL PRS-RSRP value shall not be lower than the corresponding SL PRS-RSRP of any of the individual receiver branches. SL PRS-RSRP measurements are applicable for UE 402 in RRC_CONNECTED and/or RRC_IDLE.

The requirements for SL-RSRP measurements apply for periodic, aperiodic, and triggered SL PRS-RSRP measurements, provided that the SL PRS-RSRP related side conditions for FR1 are fulfilled for a corresponding band.

The UE SL PRS-RSRP measurement capability is as indicated by the UE 402 in sl-TDOA-ProvideCapabilities, sl-RTT-ProvideCapabilities, sl-AOA-ProvideCapabilities, or sl-TOA-ProvideCapabilities, according to [TS38355]. The SL-TDOA-ProvideCapabilities IE is the same or similar as discussed previously. The sl-RTT-ProvideCapabilities IE, sl-AOA-ProvideCapabilities IE, and sl-TOA-ProvideCapabilities IE each include an applicationLayerID, a periodicalReporting, and a tenMsUnitResponseTime, which are the same or similar as discussed previously. The sl-RTT-ProvideCapabilities IE also includes a positioningModes which specifies the SL-RTT mode(s) supported by the UE 402; the sl-AOA-ProvideCapabilities IE also includes a positioningModes which specifies the SL-AoA mode(s) supported by the UE 402; and the sl-TOA-ProvideCapabilities IE also includes a positioningModes which specifies the SL-TOA mode(s) supported by the UE 402.

The measurement reporting delay is defined as the time between the moment when the measurement report is triggered and the moment when the UE 402 starts to transmit the measurement report over the air interface.

For a UE 402 reporting to the LMF 470, this measurement reporting requirement assumes that the measurement report is not delayed by other SLPP signalling on the DCCH or SCCH. This measurement reporting delay excludes a delay uncertainty resulted when inserting the measurement report to the TTI of the uplink DCCH or SCCH. The delay uncertainty is: 2×TTIDCCH/SCCH where TTIDCCH/SCCH is the duration of subframe or slot or subslot when the measurement report is transmitted on the PUSCH with subframe or slot or subslot duration.

For a UE 402 reporting to another UE 402, this measurement reporting requirement assumes that the measurement report is not delayed by other SLPP signalling on the STCH. This measurement reporting delay excludes a delay uncertainty resulted when inserting the measurement report to the TTI of the transmitted STCH. The delay uncertainty is: 2×TTISTCH where TTISTCH is the duration of subframe or slot or subslot when the measurement report is transmitted on the PSSCH with subframe or slot or subslot duration.

The measurement reporting delay excludes any delay caused by no SL resources and/or SL-PRS resources for the UE 402 to send the measurement report.

The reported SL PRS-RSRP measurement values contained in measurement reports are based on the measurement report mapping requirements, which may be predefined and/or configured. In one example, the measurement report mapping requirements include a reporting range is defined from −985024T_{c} to +985024×T_{c}, and a reporting resolution that is uniform across the reporting range and defined as T=T_{c}*2^{k} where k is selected by a gNB 414a or UE 402 from the set {0, 1, 2, 3, 4, 5}, and wherein T_{c} is defined in [TS38211]. In this example, the LMF 470 provides a recommended resolution parameter, timingReportingGranularityFactor, and the selected parameter k based on timingReportingGranularityFactor is indicated to the LMF LMF 470. Additionally or alternatively, the mapping of measured quantity for each reporting resolution (k) is defined in Tables 13.2.1-1 to 13.2.1-6 in [TS38133]. Additionally or alternatively, the reporting range and defined as T=T_{c}*32 and mapping of measured quantity is defined in Table 13.7.1-1 in [TS38133]. Additionally or alternatively, the measurement report mapping requirements include a reporting range of additional path reporting defined from −8175×T_{c} to +8175×T_{c}. The reporting resolution is uniform across the reporting range and is defined as T=T_{c}*2^{k} where k is selected by a gNB 414a or UE 402 from the set {0, 1, 2, 3, 4, 5}, and wherein T_{c} is defined in [TS38211]. In this example, the LMF 470 provides a recommended resolution parameter, timingReportingGranularityFactor, and the selected parameter k based on timingReportingGranularityFactor is indicated to the LMF LMF 470. Additionally or alternatively, the mapping of measured quantity for each reporting resolution (k) is defined in Tables 13.2.1A-1 to 13.2.1A-6 in [TS38133]. Additional or alternative measurement report mapping requirements can be used in other implementations.

The SL PRS-RSRP measurements performed and reported according to this section is to meet the SL PRS-RSRP measurement accuracy requirements, for each measured SL-PRS resource, which may be predefined and/or configured. In one example, the accuracy requirements for SL Rx-Tx time difference measurements and/or SL-RTT includes being within + (X+Y) T_{c} under the one or more conditions, such as additive white Gaussian noise (AWGN) propagation conditions, reference sensitivity requirements, and/or the like.

The measurement period requirements for SL-RSRP include, for example, when the physical layer receives last of: sl-TDOA-ProvideAssistanceData message and sl-TDOA-RequestLocationInformation message; sl-AOA-ProvideAssistanceData message and sl-AOA-RequestLocationInformation message; sl-TOA-ProvideAssistanceData message and sl-TOA-RequestLocationInformation message; or sl-RTT-ProvideAssistanceData message and sl-RTT-RequestLocationInformation message from the LMF 470 or another UE 402 via SLPP (see e.g., [TS38355]), the UE 402 is able to perform at least Y SL PRS-RSRP measurements (where Y is a number, which may be predefined, configured, and/or up to UE implementation), defined in [TS38215], during the measurement period T_{SL PRS-RSRP,Total} defined as:

$${T}_{SL PRS - RSRP , Total} = {\sum }_{s = 1}^{S} {T}_{SL PRS - RSRP , effect , s}$$

where S is the number of samples per measured link, defined as S=1 for SL-PRS BW>48 PRBs, and/or S=4 for 24 PRBs≤SSL-PRS BW≤48 PRBs; T_{dur,s} is the SL-PRS duration for SL-PRS sample s of the SL PRS-RSRP measurement; Δ_{SLproc} is the processing time, which may be predefined, configured, or implementation-specific; and T_{SL PRS-RSRP,effect,s}=tₛ₊₁−tₛ, for s<S, provided that T_{SL PRS-RSRP,effect,s}≥T_{dur,s}+Δ_{SLproc}, where tₛ₊₁ and tₛ are the beginning of the first slot corresponding to the next and current SL-PRS samples, respectively, in which the UE 402 is configured to receive SL-PRS for performing the SL-RSTD measurement, or T_{SL PRS-RSRP,effect,s}=T_{dur,s}+Δ_{SLproc}, for s=S.

If the synchronization reference source changes at the measuring UE 402 or at the UE 402 configured to transmit SL-PRS for the SL PRS-RSRP measurement, while the measuring UE 402 is performing the SL PRS-RSRP measurement, then the UE 402 continues performing the SL PRS-RSRP measurement after the synchronization reference source change, while meeting the measurement period T_{SL PRS-RSRP,Total} defined in this clause and predefined and/or configured accuracy requirements.

### 1.2.3. SL-RX-Tx Measurements

The requirements for SL-Rx-Tx measurements apply provided the UE has received NR-SL-RxTx-RequestLocationInformation (or a CommonIEsRequestLocationInformation message, CommonSL-PRS-MethodsIEsRequestLocationInformation message, SL-TDOA-RequestLocationInformation message, SL-TOA-RequestLocationInformation message, SL-RTT-RequestLocationInformation message, and/or the like) from the LMF 470 or another UE via SLPP requesting the UE to measure and report SL Rx-Tx time difference measurements defined in [TS38215] based on SL-PRS.

The SL Rx-Tx time difference at a UE 402 is defined as TUE-RX-TUE-TX, where: TUE-RX is the UE 402 received timing of SL subframe #i from a transmitting UE 402, defined by the first detected path in time. If the UE 402 reports the transmission timestamp of a SL PRS, TUE-TX is the transmit timing of the SL subframe #j of the SL PRS of the UE 402. Otherwise, TUE-TX is the transmit timing of the UE 402 of SL subframe #j that is closest in time to the subframe #i received from the transmitting UE 402. The same antenna reference point is used for receiver and transmitter for the Rx-Tx time difference measurement. If the UE 402 reports the transmission timestamp of a SL PRS, the SL Rx-Tx time difference is modulo wrapped around to result in values between −0.5 ms to +0.5 ms.

For FR1, the reference point for TUE-RX measurement is the Rx antenna connector of the UE 402 and the reference point for TUE-TX measurement is the Tx antenna connector of the UE 402. For FR2, the reference point for TUE-RX measurement shall be the Rx antenna of the UE 402 and the reference point for TUE-TX measurement shall be the Tx antenna of the UE 402.

The requirements for SL-Rx-Tx measurements apply for periodic, aperiodic, and triggered SL Rx-Tx time difference measurements, provided that the SL Rx-Tx time difference related side conditions for FR1 are met for a corresponding band; and/or the actual time difference between the corresponding SL-PRS transmission and reception used to derive the measurement is no larger than ms.

The SL Rx-Tx time difference measurement capability is as indicated by the UE 402 in NR-SL-RxTx-ProvideCapabilities (or sl-TDOA-ProvideCapabilities, sl-RTT-ProvideCapabilities, sl-AOA-ProvideCapabilities, or sl-TOA-ProvideCapabilities) according to [TS38355].

The measurement reporting delay is defined as the time between the moment when the measurement report is triggered and the moment when the UE starts to transmit the measurement report over the air interface.

For UE report to the LMF 470, this requirement assumes that the measurement report is not delayed by other SLPP signalling on the DCCH. This measurement reporting delay excludes a delay uncertainty resulted when inserting the measurement report to the TTI of the uplink DCCH. The delay uncertainty is: 2×TTIDCCH where TTIDCCH is the duration of subframe or slot or subslot when the measurement report is transmitted on the PSSCH with subframe or slot or subslot duration.

For UE 402 report to another UE 402, this requirement assumes that the measurement report is not delayed by other SLPP signalling on the STCH. This measurement reporting delay excludes a delay uncertainty resulted when inserting the measurement report to the TTI of the SL STCH. The delay uncertainty is: 2×TTISTCH where TTISTCH is the duration of subframe or slot or subslot when the measurement report is transmitted on the PSSCH with subframe or slot or subslot duration.

The measurement reporting delay excludes any delay caused by no SL resources and/or SL-PRS resources for UE to send the measurement report.

The reported SL Rx-Tx time difference measurement values contained in measurement reports is to be based on the measurement report mapping requirements, which may be predefined, configured, and/or implementation-specific. In one example, the measurement report mapping requirements include a reporting range is defined from −985024T_{c} to +985024×T_{c}, and a reporting resolution that is uniform across the reporting range and defined as T=T_{c}*2^{k} where k is selected by a gNB 414a or UE 402 from the set {0, 1, 2, 3, 4, 5}, and wherein T_{c} is defined in [TS38211]. In this example, the LMF 470 provides a recommended resolution parameter, timingReportingGranularityFactor, and the selected parameter k based on timingReportingGranularityFactor is indicated to the LMF LMF 470. Additionally or alternatively, the mapping of measured quantity for each reporting resolution (k) is defined in Tables 13.2.1-1 to 13.2.1-6 in [TS38133]. Additionally or alternatively, the reporting range and defined as T=T_{c}*32 and mapping of measured quantity is defined in Table 13.7.1-1 in [TS38133]. Additionally or alternatively, the measurement report mapping requirements include a reporting range of additional path reporting defined from −8175×T_{c} to +8175×T_{c}. The reporting resolution is uniform across the reporting range and is defined as T=T_{c}*2^{k} where k is selected by a gNB 414a or UE 402 from the set {0, 1, 2, 3, 4, 5}, and wherein T_{c} is defined in [TS38211]. In this example, the LMF 470 provides a recommended resolution parameter, timingReportingGranularityFactor, and the selected parameter k based on timingReportingGranularityFactor is indicated to the LMF LMF 470. Additionally or alternatively, the mapping of measured quantity for each reporting resolution (k) is defined in Tables 13.2.1A-1 to 13.2.1A-6 in [TS38133]. Additional or alternative measurement report mapping requirements can be used in other implementations.

The SL Rx-Tx time difference measurements performed and reported according to this section is to meet the SL Rx-Tx time difference measurement accuracy requirements for each measured SL-PRS resource, which may be predefined, configured, and/or implementation-specific. In one example, the accuracy requirements for SL Rx-Tx time difference measurements include being within ±(X+Y) T_{c} under the one or more conditions, such as Ês/Iot≥+3 dB or Ês/Iot ≥−13 dB, AWGN propagation conditions, reference sensitivity requirements, and/or the like.

When the physical layer receives NR-SL-RxTx-ProvideAssistanceData message from NR-SL-RxTx-RequestLocationInformation message from the LMF 470 or another UE 402 via SLPP, the UE 402 is able to perform multiple at least Z SL Rx-Tx time difference measurements (where Z is a number, which may be predefined, configured, and/or up to UE implementation), defined in [TS38215], during T_{SL RxTx,total} defined as:

$${T}_{SL RxTx , total} = {\sum }_{s = 1}^{S} {T}_{SL RxTx , effect , s} + {T}_{uncertain}$$

where, S is the number of samples for a single SL Rx-Tx measurement defined as S=1 for SL-PRS BW>48 PRBs, or S=4 for 24 PRBs≤SSL-PRS BW≤48 PRBs; T_{SL RxTx,effect,s} is defined as T_{SL RxTx,effect,s}=tₛ₊₁−tₛ, for s<S, provided that T_{SL RxTx,effect,s}≥T_{dur,s}+Δ_{SLproc}, where tₛ and tₛ₊₁ are the start of the s-th and (s+1)-th slot, respectively, where UE is configured to measure SL-PRS, or T_{SL RxTx,effect,s}=T_{dur,s}+Δ_{SLproc}, for s=S; T_{dur,s} is the duration of SL-PRS resources of the s-th sample; Δ_{SLproc}=[TBD] is the processing time; T_{uncertain} is defined as follow: if the UE 402 reports the transmission timestamp of a SL PRS as defined in [TS38215], and the SL PRS transmission occurs after the SL PRS reception used to derive the measurement, T_{uncertain} is the additional time delay from the SL PRS reception until the actual SL PRS transmission, otherwise, T_{uncertain}=0.

In some examples, the SL PRS measurement period for measurement on SL-PRS for multiple UEs 402 is for future study.

In some examples, the synchronization reference source changes at the measuring UE 402 or at the UE 402 configured to transmit SL-PRS for the measurement, while the measuring UE 402 is performing the SL Rx-Tx time difference measurement, then the measuring UE 402 restarts the SL Rx-Tx time difference measurement and sends the measurement report no later than: T_{SL RxTx,restart}=(K+1)*T_{SL RxTx,Total}, where K is the number of restarts due to the synchronization source changes. In some examples, it is for future study whether to limit the number of restarting.

### 1.3. NR Sidelink Positioning

SL positioning provides absolute location, geographic location, relative position, relative location, and/or ranging information (e.g., range and/or direction) of a UE 402 by using the PC5 interface (see e.g., FIGS. 5, 6, and 7) for at least the positioning. In some examples, SL positioning can be used to provide a velocity of a UE 402, such as a relative velocity of a UE 402. A located UE 402l can be used to determine the absolute location of a target UE 402t using SL positioning.

The ranging/SL positioning (RSP) operation can be performed with NW-assisted operation, NW-based operation, or UE-only operation. In the NW-assisted operation, one or more 5GC network functions (NFs) is/are involved for the service request handling and assist the UE 402 for the result calculation. In the NW-based operation, one or more 5GC NFs is/are involved for the service request handling and result calculation. In the UE-only operation, the service request handling and result calculation are performed by a UE 402.

The result calculation in each of the aforementioned RSP operation modes may be obtained for a target UE 402t, and can include any information obtained using SL positioning (e.g., absolute location, geographic location, relative position, relative location, ranging information, location results as discussed in 3GPP TS 23.032 (“[TS23032]”), and/or any other type of information, such as any information discussed herein).

The purpose of the NR SL positioning procedure is to perform NR SL positioning as discussed herein and/or as specified in [TS38305], [TS23586], and/or the like. For SLPR using SL-RTT, SL-AoA, SL-TDOA, and SL-TOA methods, UEs 402 transmit and/or receive SL-PRS as specified in [TS38211] over the NR PC5 interface (see e.g., FIGS. 5, 6, and 7). A UE 402 can be configured with one or more SL resource pools via system information (SI) or dedicated signaling (e.g., via downlink control information (DCI) format 3_0, DCI format 3_2, and/or some other DCI format; and/or sidelink control information (SCI) format 1-B, SCI format 2-D, and/or some other SCI format) while inside NG-RAN coverage or pre-configuration while outside NG-RAN coverage as specified in [TS38331].

A SL-PRS resource refers to a time-frequency resource within a slot, used for SL-PRS transmission. An SL resource pool that can be used for transmission of both, SL-PRS and SL data is referred to as an SL-PRS shared resource pool. In a shared SL-PRS resource pool, the OFDM symbol immediately preceding the symbols that are configured for use by PSFCH (if PSFCH is configured in this slot), and the last symbol configured for SL in a slot, serve as guard symbol(s) (see e.g., [TS38211] § 8.3.4.2.2). An SL resource pool that can be used for transmission of SL-PRS and cannot be used for transmission of SL data is referred to as an SL-PRS dedicated resource pool. In a dedicated SL-PRS resource pool, the last symbol configured for SL in a slot serves as a guard symbol (see e.g., [TS38211] § 8.4.1.6.3). Otherwise, the OFDM symbol immediately following the last symbol used for PSSCH, PSFCH, or S-SSB serves as a guard symbol (see e.g., [TS38211] §§ 8.3.1.5 and 8.3.2.3).

Two SL resource allocation schemes for SL-PRS are supported: scheme 1 and scheme 2. In scheme 1, the SL-PRS resource allocation is provided by the NW (e.g., the NG-RAN 404 schedules transmission resources), and the UE 402 is in the RRC_CONNECTED state in order to transmit SL-PRS. In scheme 2, the UE 402 decides the SL-PRS transmission resources in the resource pool(s), and the UE 402 can transmit SL-PRS when inside NG-RAN coverage irrespective of which RRC state the UE 402 is in, and when outside NG-RAN coverage. Additionally, the UE autonomously selects transmission resources from resource pool(s).

### 1.3.1. NR Sidelink Positioning Reception

A UE 402 capable of NR SL positioning that is configured by upper layers for reception of SL-PRS performs the following operations if the conditions for NR SL positioning operation as defined in [TS38331] § 5.8.2 (see e.g., section 1.3.3, infra) are met:

If the frequency used for NR SL positioning is included in sl-FreqInfoToAddModList in RRCReconfiguration message or sl-FreqInfoList included in SIB23; and if the UE 402 is configured with sl-RxPool and/or sl-PRS-RxPool included in RRCReconfiguration message with reconfigurationWithSync (e.g., handover): configure lower layers to monitor SL control information and the corresponding SL-PRS using the pool(s) of resources indicated by sl-RxPool and/or sl-PRS-RxPool; else if the cell chosen for NR SL positioning provides SIB23: configure lower layers to monitor SL control information and the corresponding SL-PRS using the pool(s) of resources indicated by sl-RxPool and/or sl-PRS-RxPool in SIB23.

If the frequency used for NR SL positioning is not included in sl-FreqInfoToAddModList in RRCReconfiguration message or sl-FreqInfoList included in SIB23, configure lower layers to monitor SL control information and the corresponding SL-PRS using the pool(s) of resources that were preconfigured by sl-RxPool and/or sl-PRS-RxPool in SL-PreconfigurationNR, as defined in [TS38331] § 9.3.

### 1.3.2. NR Sidelink Positioning Transmission

A UE 402 capable of NR SL positioning that is configured by upper layers to transmit SL-PRS performs the following operations if the conditions for NR SL positioning operation as defined in [TS38331] § 5.8.2 (see e.g., section 1.3.3, infra) are met:

If the frequency used for NR SL positioning is included in sl-FreqInfoToAddModList in sl-ConfigDedicatedNR within RRCReconfiguration in message or included sl-PosConfigCommonNR within SIB23:
if the UE is in RRC_CONNECTED and uses the frequency included in sl-ConfigDedicatedNR within RRCReconfiguration message:
if the UE is configured with sl-ScheduledConfig: if T310 for MCG or T311 is running; and if sl-PRS-TxPoolExceptional or sl-TxPoolExceptional is included in sl-FreqInfoList for the concerned frequency in SIB23 or included in sl-ConfigDedicatedNR in RRCReconfiguration; if T301 is running and the cell on which the UE initiated RRC connection re-establishment provides SIB23 including sl-PRS-TxPoolExceptional or sl-TxPoolExceptional for the concerned frequency; or if T304 for MCG is running and the UE is configured with sl-PRS-TxPoolExceptional or sl-TxPoolExceptional included in sl-ConfigDedicatedNR for the concerned frequency in RRCReconfiguration: configure lower layers to perform the SL resource allocation scheme 2 based on random selection using the resource pool indicated by sl-PRS-TxPoolExceptional or sl-TxPoolExceptional as defined in [TS38321]; else: configure lower layers to perform the SL resource allocation scheme 1 for NR SL positioning; if T311 is running, configure the lower layers to release the resources indicated by rrc-ConfiguredSidelinkGrant (if any);
if the UE is configured with sl-UE-SelectedConfig: if a result of full sensing, if selected and is allowed by sl-PosAllowedResourceSelectionConfig, on the resources configured in sl-PRS-TxPoolSelectedNormal or by sl-AllowedResourceSelectionConfig, on the resources configured in sl-TxPoolSelectedNormal for the concerned frequency included in sl-ConfigDedicatedNR within RRCReconfiguration is not available in accordance with [TS38214]; if sl-TxPoolExceptional or sl-PRS-TxPoolExceptional for the concerned frequency is included in RRCReconfiguration or if the PCell provides SIB25 including sl-TxPoolExceptional or sl-PRS-TxPoolExceptional in sl-FreqInfoList for the concerned frequency: configure lower layers to perform the SL resource allocation scheme 2 based on random selection using the pool of resources indicated by sl-TxPoolExceptional or sl-PRS-TxPoolExceptional as defined in [TS38321];
else, if the sl-PRS-TxPoolSelectedNormal or sl-TxPoolSelectedNormal for the concerned frequency is included in the sl-ConfigDedicatedNR within RRCReconfiguration: configure lower layers to perform the SL resource allocation scheme 2 based on resource selection operation according to sl-PosAllowedResourceSelectionConfig (as defined in [TS38321] and [TS38214]) using the pools of resources indicated by sl-PRS-TxPoolSelectedNormalNormal for the concerned frequency, or based on resource selection operation according to sl-AllowedResourceSelectionConfig (as defined in [TS38321] and [TS38214]) using the pools of resources indicated by sl-TxPoolSelectedNormal for the concerned frequency;
if the UE is in not in RRC_CONNECTED and/or does not use the frequency included in sl-ConfigDedicatedNR within RRCReconfiguration message:
if the cell chosen for NR SL positioning transmission provides SIB23: if SIB23 includes sl-PosTxPoolSelectedNormal for the concerned frequency, and a result of full sensing, if selected and is allowed by sl-PosAllowedResourceSelectionConfig, on the resources configured in the sl-PRS-TxPoolSelectedNormal is available in accordance with [TS38214] or random selection, if allowed by sl-PosAllowedResourceSelectionConfig, is selected: configure lower layers to perform the SL resource allocation scheme 2 based on resource selection operation according to sl-PosAllowedResourceSelectionConfig using the pools of resources indicated by sl-PosTxPoolSelectedNormal for the concerned frequency as defined in [TS38321];
if SIB23 includes sl-TxPoolSelectedNormal for the concerned frequency, and a result of full sensing, if selected and is allowed by sl-AllowedResourceSelectionConfig, on the resources configured in the sl-TxPoolSelectedNormal is available in accordance with [TS38214] or random selection, if allowed by sl-AllowedResourceSelectionConfig, is selected: configure lower layers to perform the SL resource allocation scheme 2 based on resource selection operation according to sl-AllowedResourceSelectionConfig using the pools of resources indicated by sl-TxPoolSelectedNormal for the concerned frequency as defined in [TS38321];
else if SIB23 includes sl-PRS-TxPoolExceptional or sl-TxPoolExceptional for the concerned frequency: from the moment the UE initiates RRC connection establishment or RRC connection resume, until receiving an RRCReconfiguration including sl-ConfigDedicatedNR, or receiving an RRCRelease or an RRCReject; or if a result of full sensing, if selected and is allowed by sl-PosAllowedResourceSelectionConfig, on the resources configured in sl-PRS-TxPoolSelectedNormal or if selected and is allowed by sl-AllowedResourceSelectionConfig, on the resources configured in sl-TxPoolSelectedNormal for the concerned frequency in SIB23 is not available in accordance with [TS38214]: configure lower layers to perform the SL resource allocation scheme 2 based on random selection (as defined in [TS38321]) using the pool of resources indicated by sl-PRS-TxPoolExceptional or sl-TxPoolExceptional for the concerned frequency.

If the frequency used for NR SL positioning is not included in sl-FreqInfoToAddModList in sl-ConfigDedicatedNR within RRCReconfiguration message or included in sl-PosConfigCommonNR within SIB23, configure lower layers to perform the SL resource allocation scheme 2 based on resource selection operation according to sl-PosAllowedResourceSelectionConfig (as defined in [TS38321] and [TS38214]) using the pools of resources indicated by sl-PRS-TxPoolSelectedNormal in SL-PosPreconfigurationNR for the concerned frequency or based on sl-AllowedResourceSelectionConfig (e.g., as defined in [TS38321] and [TS38214]) using the pools of resources indicated by sl-TxPoolSelectedNormal in SidelinkPreconfigNR for the concerned frequency.

### 1.3.3. Conditions for Nr Sidelink Communication/Discovery/Positioning Operation

The UE 402 performs NR SL communication/positioning operation if the following conditions are met:
(i) If the UE's 402 serving cell is suitable (RRC_IDLE, RRC_INACTIVE, or RRC_CONNECTED); and if either the selected cell on the frequency used for NR SL communication/discovery/positioning operation belongs to the registered or equivalent PLMN as specified in 3GPP TS 24.587 or 3GPP TS 24.554 or the UE 402 is out of coverage on the frequency used for NR SL communication/discovery/positioning operation as defined in 3GPP TS 38.304 and 3GPP TS 36.304;
(ii) If the UE's 402 serving cell (RRC_IDLE or RRC_CONNECTED) fulfils the conditions to support NR SL communication/discovery/positioning in limited service state as specified in 3GPP TS 23.287; and if either the serving cell is on the frequency used for NR SL communication/discovery/positioning operation or the UE 402 is out of coverage on the frequency used for NR SL communication/discovery/positioning operation as defined in 3GPP TS 38.304 and 3GPP TS 36.304; or
(iii) The UE 402 has no serving cell (RRC_IDLE).

### 1.4. Ranging Based Services

Ranging based service provides the distance between two or more UEs 402 and/or the direction of one UE 402 (e.g., a target UE 402t) from another UE 402 (e.g., an SL reference UE 402) via PC5 operations. Additionally, ranging based services include applications utilizing the distance between two or more UEs 402 and/or the direction of one UE 402 from another UE 402. In three dimensional (3D) cases, the direction includes at least a horizontal direction (or horizontal component) and an elevation direction (or vertical component). Ranging based services can apply to a variety of verticals, such as consumer, smart home, smart city, smart transportation (including (semi-) autonomous terrestrial, aquatic, and aerial vehicles), smart retail, industry 4.0, among many others. Some ranging based services can require a distance measurement, a direction measurement, or both distance and direction measurements. Ranging can be supported with or without 5G coverage.

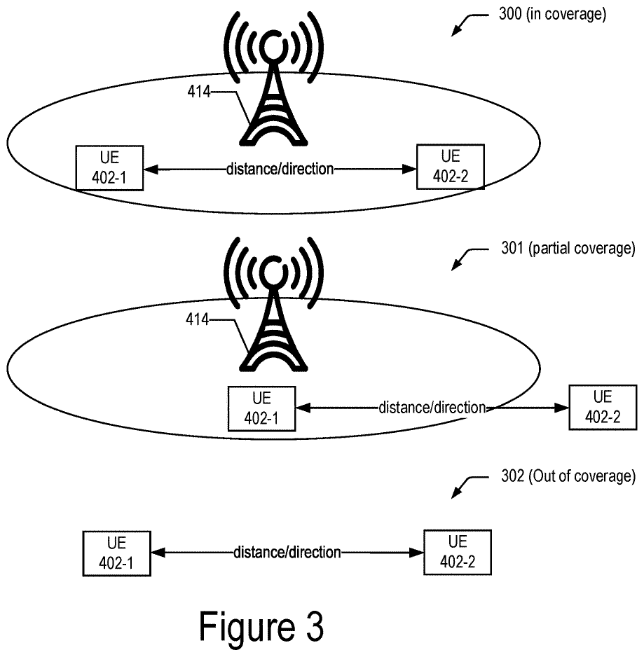

FIG. 3 illustrates examples of ranging between UEs 402 (e.g., UE 402-1 and UE 402-2) that are in coverage 300, out of coverage 302, or with partial coverage 301. Both licensed and unlicensed spectrum can be used for ranging. In some implementations, if licensed spectrum is used, it is fully under operator control.

In several scenarios, it can be beneficial to determine the distance between two or more UEs 402 and/or the direction of one UE 402 from another UE 402 via direct communication connection. The functional requirements related to ranging based services are discussed herein and in [TS22261] § 6.37. Performance requirements for ranging based services in different scenarios can be found in table 7.9-1 of [TS22261]. Example KPIs and key attributes for ranging are shown by table 1.4-1.

TABLE 1.4-1
KPIs and key attributes for ranging

| KPI | Description |
|---|---|
| Ranging accuracy | describes the absolute value of the deviation of the measured distance and/or |
| | direction between two UEs to the true distance and/or direction value |
| Confidence level | describes the percentage of all the possible measured distance and/or direction that |
| | can be expected to include the true distance and/or direction considering the ranging |
| | accuracy |
| Effective | the largest distance between the UE who initiates the ranging and target UEs in the |
| ranging distance | ranging operation |
| Line-of-sight | the environment between the UE who initiates the ranging and target UEs, such as |
| (LOS) | LOS and non-LOS (NLOS) |
| Environment | |
| Coverage | type of radio coverage conditions of the UEs who are involved in ranging, such as in |
| | coverage (IC), partial coverage (PC) and out of coverage (OOC) (see e.g., FIG. 3). |
| | If using licensed spectrum, ranging is only permitted in network coverage under the |
| | full control of the operator who provides the coverage, except for public safety |
| | networks with dedicated spectrum where ranging might be allowed out of coverage or |
| | in partial coverage as well |
| Relative UE | the target UE can be either static or mobile relative to the UE who initiates the |
| velocity | ranging. In the latter, the attribute shall also provide some elements about its motion |
| | (e.g., maximum speed, trajectory, and/or the like) |
| Availability | percentage value of the amount of time when a ranging system is able to provide the |
| | required ranging-related data within the performance targets or requirements divided |
| | by the amount of time the system is expected to provide the ranging service in a |
| | targeted service area |
| Latency | time elapsed between the event that triggers the determination of the ranging-related |
| | data and the availability of the ranging-related data at the ranging system interface |
| Ranging interval | time difference between two consecutive ranging operations |

### 1.5. Sidelink Positioning and Ranging Methods

SLPR methods based on SL signals include SL round trip time (SL-RTT) positioning, SL angle-of-arrival (SL-AoA) positioning, SL time difference of arrival (SL-TDOA) positioning, SL time of arrival (SL-TOA) positioning, and SL relative time of arrival (SL-RTOA) positioning. The SLPR methods may be supported in SL-target UE-based or SL-target UE-assisted/server-based mode, where the “server” may be an SL server UE 402 or LMF 470. Table 1.5-1 indicates which of these versions are supported in this version of the specification for the SLPR methods.

TABLE 1.5-1
Supported versions of SLPR methods

| | | SL-Target UE-assisted, |
|---|---|---|
| Method | SL-Target UE-based | server-based |
| SL-RTT^{NOTE 1} | Yes | Yes |
| SL-AoA^{NOTE 2} | Yes | Yes |
| SL-TDOA | Yes | Yes |
| SL-TOA | Yes | Yes |

^{NOTE 1}
The SL-RTT method may also be used for ranging between UEs.
^{NOTE 2}
The SL-AoA method may also be used to obtain direction between UEs.

The SL-RTT positioning method makes use of SL Rx-Tx time difference measurements (and optionally SL-PRS-RSRP and/or SL-PRS-RSRPP) of SL signals received at the target UE 402t from one or more peer UEs 402 (e.g., anchor UEs 402) and the SL Rx-Tx time difference measurements (and optionally SL-PRS-RSRP and/or SL-PRS-RSRPP) performed at the one or more peer UEs 402 (e.g., anchor UEs 402) of SL signals transmitted by the target UE 402t. The SL Rx-Tx time difference measurements performed by a pair of UEs 402 allows determining the distance/range between the pair of UEs 402. Distance/range measurements between a target UE 402t and multiple peer UEs 402 can be used to determine the location of the target UE 402t relative to the locations of the peer UEs (e.g., anchor UEs 402). Operations of the SL-RTT positioning method is described in [TS38305] § 8.15.2.

In some examples, the SL-RTT positioning method makes use of SL Rx-Tx time difference measurements performed by a pair of UEs 402 (e.g., target UE 402t and anchor UE 402). Both UEs 402 measure the Rx-Tx time difference using the SL-PRS transmitted/received by the pair of UEs 402. The SL Rx-Tx time difference measurements performed by a pair of UEs 402 defines the RTT between the UEs 402, which can be converted into a range estimate between the pair of UEs 402. For SL-RTT, the pair of UEs 402 may transmit and receive SL-PRS once (also referred to as “single-sided RTT”) or multiple times (also referred to as “double-sided RTT”). In some examples, a UE 402 may report multiple SL Rx-Tx time difference measurements for the same SL-PRS transmission and up to four different SL-PRS receptions, or report multiple SL Rx-Tx time difference measurements for the same SL-PRS reception and up to four different SL-PRS transmissions, or both.

The SL-AoA positioning method makes use of SL AoA measurements (and optionally SL-PRS-RSRP and/or SL-PRS-RSRPP) of SL signals received at the target UE 402t from one or more peer UEs 402 (e.g., anchor UEs 402) or SL AoA measurements (and optionally SL-PRS-RSRP and/or SL-PRS-RSRPP) performed at one or more peer UEs (e.g., anchor UE 402) of SL signals transmitted by a target UE 402t. The SL AoA measurements performed by a UE 402 of SL signals transmitted by a peer UE 402 determines the azimuth and vertical angle (e.g., the direction) between the pair of UEs 402 relative to a reference direction (e.g., geographical North and/or some other geographical direction(s)). Direction measurements between a target UE 402t and multiple peer UEs 402 can be used to determine the location of the target UE relative to the locations of the peer UEs 402 (e.g., anchor UEs 402). Operations of the SL-AoA positioning method is described in [TS38305] § 8.15.3.

The SL-TDOA positioning method makes use of SL-RSTD (and optionally SL-PRS-RSRP and/or SL-PRS-RSRPP) of SL signals received at the target UE 402t from two or more peer UEs 402 (e.g., anchor UEs 402). The target UE 402t measures the SL-RSTD (and optionally SL-PRS-RSRP and/or SL-PRS-RSRPP) of the received SL signals transmitted by two or more peer UEs 402. SL-RSTD measurements between a target UE 402t and multiple peer UEs 402 can be used to determine the location of the target UE 402t relative to the locations of the peer UEs 402 (e.g., anchor UEs 402). Operations of the SL-TDOA positioning method is described in [TS38305] § 8.15.4.

In some examples, the SL-TDOA positioning method makes use of SL-RSTD measurements of SL-PRS received at the target UE 402t from two or more peer UEs 402 (e.g., anchor UEs 402). The target UE 402t measures the SL-RSTD of the received SL-PRS transmitted by two or more peer UEs 402. The target UE position is estimated based on the SL-RSTD measurements and the knowledge of the geographical coordinates of the peer UEs 402 (e.g., anchor UEs 402) and their relative SL timing.

The SL-TOA positioning method makes use of SL-RTOA (and optionally SL-PRS-RSRP and/or SL-PRS-RSRPP) of SL signals transmitted by a target UE 402t and received by multiple per UEs 402 (e.g., anchor UEs 402). The peer UEs 402 measure the SL-RTOA (and optionally SL-PRS-RSRP and/or SL-PRS-RSRPP) of the SL signals transmitted by the target UE. SL-RTOA measurements performed at multiple peer UEs 402 can be used to determine the location of the target UE 402t relative to the locations of the peer UEs 402 (e.g., anchor UEs 402). Operations of the SL-TOA positioning method is described in [TS38305] § 8.15.5.

In some examples, the SL-TOA positioning method makes use of SL-RTOA measurements performed at multiple peer UEs 402 (e.g., anchor UEs 402). The target UE 402t transmits SL-PRS and the peer UEs 402 (e.g., anchor UEs 402) measures the SL-RTOA relative to the peer UEs 402 (e.g., anchor UEs 402) own time base. The target UE position is estimated based on the SL-RTOA measurements and the knowledge of the geographical coordinates of the peer UEs 402 (e.g., anchor UEs 402) and their relative SL timing.

### 2. Network, System, and Device Configurations and Arrangements

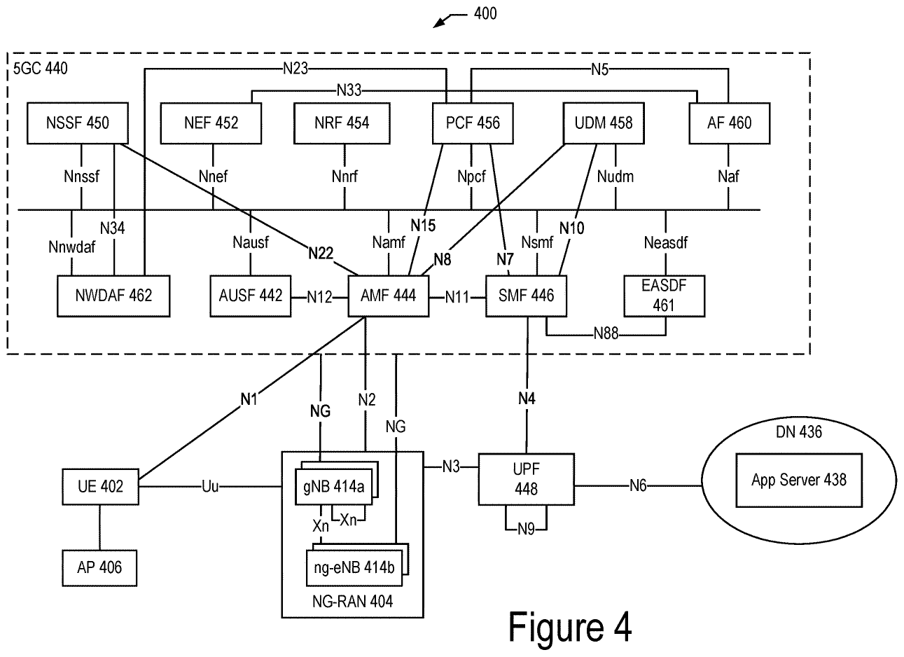

FIG. 4 depicts an example network architecture 400. The network 400 may operate in a manner consistent with 3GPP technical specifications for LTE or 5G/NR systems. However, the example embodiments are not limited in this regard and the described examples may apply to other networks that benefit from the principles described herein, such as future 3GPP systems, WiMAX systems, GSMA systems, WiFi systems, and/or the like.

The network 400 includes a UE 402, which is any mobile or non-mobile computing device designed to communicate with a RAN 404 via an over-the-air connection. The UE 402 is communicatively coupled with the RAN 404 by a Uu interface, which may be applicable to both LTE and NR systems. Examples of the UE 402 include, but are not limited to, a smartphone, tablet computer, wearable device (e.g., smart watch, fitness tracker, smart glasses, smart clothing/fabrics, head-mounted displays, smart shows, and/or the like), desktop computer, workstation, laptop computer, servers, in-vehicle infotainment system, in-car entertainment system, instrument cluster, head-up display (HUD) device, extended reality (XR) device (e.g., including augmented reality, virtual reality (VR), and/or mixed reality), onboard diagnostic device, dashtop mobile equipment, mobile data terminal, electronic engine management system, engine management system, electronic/engine control unit/module, embedded system, sensor, microcontroller, control module, networked appliance, machine-type communication device, machine-to-machine (M2M), Internet of Things (IoT) device, smart appliance, flying drone or unmanned aerial vehicle (UAV), terrestrial drone or autonomous vehicle, robot, electronic signage, single-board computer (SBC) (e.g., Raspberry Pi, Arduino, Intel Edison, and the like), plug computers, and/or any type of computing device such as any of those discussed herein. In some examples, the UE 402 can include desktop computers. The UE 402 may be the same or similar to any of the other UEs discussed herein such as, for example, UE 702, hardware resources 800, and/or the like.

In some examples, the network 400 includes a set of UEs 402 coupled directly with one another via a ProSe, PC5, SR5, sidelink (SL) interface, which involves communication between two or more UEs 402 using 3GPP technology without traversing a network node. Here, the SL interface includes, for example, one or more SL logical channels (e.g., SL broadcast control channel (SBCCH), SL control channel (SCCH), and SL traffic channel (STCH)); one or more SL transport channels (e.g., SL shared channel (SL-SCH) and SL broadcast channel (SL-BCH)); and one or more SL physical channels (e.g., physical SL shared channel (PSSCH), physical SL control channel (PSCCH), physical SL feedback channel (PSFCH), physical SL broadcast channel (PSBCH), and/or the like). The UE 402 may perform blind decoding attempts of SL channels/links according to the various examples herein.

In some examples, the UE 402 can communicate with an AP 406 via an over-the-air (OTA) connection. The AP 406 manages a WLAN connection between the UE 402 and the AP 406, which is consistent with any IEEE 802 protocol (e.g., IEEE 802.11 and/or the like). Additionally, the UE 402, RAN 404, and AP 406 may utilize cellular-WLAN aggregation/integration (e.g., LWA/LWIP), which may serve to offload some/all network traffic from the RAN 404.

The RAN 404 includes one or more network access nodes (NANs) 414 (also referred to as “access network nodes”, “RAN nodes”, and/or the like). The NANs 414 terminate air-interface(s) for the UE 402 by providing access stratum protocols including RRC, PDCP, RLC, MAC, and PHY/L1 protocols. In this manner, the NANs 414 enable data/voice connectivity between the CN 440 and the UE 402. The NANs 414 may be a macrocell base station or a low power base station for providing femtocells, picocells or other like cells having smaller coverage areas, smaller user capacity, or higher bandwidth compared to macrocells; or some combination thereof. In these implementations, an NAN 414 be referred to as a BS, gNB, RAN node, eNB, ng-eNB, NodeB, RSU, TRP, and the like. The RAN 404 may have an NG-RAN architecture as discussed in 3GPP TS 38.401.

The RAN 404 (or individual NANs 414) may provide the air interface over a licensed spectrum or an unlicensed spectrum. To operate in the unlicensed spectrum, the nodes may use LAA, eLAA, and/or feLAA mechanisms based on CA technology with PCells/SCells. Prior to accessing the unlicensed spectrum, the nodes may perform medium/carrier-sensing operations based on, for example, a listen-before-talk (LBT) protocol.

The set of NANs 414 are coupled with one another via respective Xn interfaces. The Xn interfaces, which may be separated into control/user plane interfaces in some examples, allow the NANs 414 to communicate information related to handovers, data/context transfers, mobility, load management, interference coordination, and the like. The NANs 414 manage one or more cells, cell groups, component carriers (CCs), and the like to provide the UE 402 with an air interface for network access. The UE 402 may be simultaneously connected with a set of cells provided by the same or different NANs 414 of the RAN 404 or a different RAN 404. For example, the UE 402 and RAN 404 may use carrier aggregation (CA) to allow the UE 402 to connect with a set of CCs, each corresponding to a primary cell (PCell) or secondary cell (SCell). The NG-RAN 404 supports multi-radio DC (MR-DC) operation where a UE 402 is configured to utilize radio resources provided by two distinct schedulers, located in at least two different NG-RAN nodes 414 connected via a non-ideal backhaul, one NG-RAN node 414 providing NR access and the other NG-RAN node 414 providing either E-UTRA or NR access. Further details of MR-DC operation, including conditional PSCell addition (CPA) and conditional PSCell change (CPC), can be found in 3GPP TS 36.300 (“[TS36300]”), [TS38300], and 3GPP TS 37.340.

Individual UEs 402 can be configured to measure or collect radio information, and provide the radio information to one or more NANs 414. The radio information may be in the form of one or more measurement reports, and/or may include, for example, signal strength measurements, signal quality measurements, and/or the like. Each measurement report can be tagged with a timestamp and the location of the measurement (e.g., the UEs 402 current location). For example, the UE 402 can perform reference signal (RS) measurement and reporting procedures to provide the NW with information about the quality of one or more wireless channels and/or the communication media in general, and this information can be used to optimize various aspects of the communication system. Additionally or alternatively, individual UEs 402 can be configured to measure or collect measurements for positioning, including DL, UL, and/or SL measurements for positioning, according to the various aspects discussed herein. As examples, the measurement and reporting procedures performed by the UE 402 can include those discussed in 3GPP TS 38.211 (“[TS38211]”), 3GPP TS 38.212 (“[TS38212]”), 3GPP TS 38.213 (“[TS38213]”), 3GPP TS 38.214 (“[TS38214]”), 3GPP TS 38.215 (“[TS38215]”), 3GPP TS 38.101-1 (“[TS38101-1]”), 3GPP TS 38.104 (“[TS38104]”), 3GPP TS 38.113 (“[TS38113]”), 3GPP TS 38.133 (“[TS38133]”), 3GPP TS 38.331 (“[TS38331]”), and/or other the like. The physical signals and/or reference signals can include demodulation reference signals (DM-RS), phase-tracking reference signals (PT-RS), positioning reference signal (PRS), channel-state information reference signal (CSI-RS), synchronization signal block (SSB), primary synchronization signal (PSS), secondary synchronization signal (SSS), sounding reference signal (SRS), and/or the like. Examples of the measurements performed/collected by individual UEs 402 and/or included in measurement reports can include one or more of the following: angle of arrival (AoA), accumulated delta range (ADR), additive white Gaussian noise (AWGN), average noise plus interference (ANPI), bandwidth (BW), bit error rate, bit error ratio (BER), block error rate (BLER), carrier-to-interference plus noise ratio (CINR), channel interference measurements, channel load measurements, channel occupancy ratio (CR), channel busy ratio (CBR), cell load, cross link interference (CLI), CLI-RSSI, CSI-RSRP, CSI-RSRQ, CSI-SINR, data rate, DL PRS-RSRP, DL PRS-RSRPP, DL RSCP, DL RSCPD, DL RSTD, DL timing drift, energy per bit to noise power density ratio (E_{b}/N₀), energy per chip to interference power density ratio (E_{c}/I₀), energy per chip to noise power density ratio (E_{c}/N₀), end-to-end (e2e) delay, GNSS carrier phase measurements, GNSS code measurements, GNSS timing of cell frames for UE positioning, GNSS carrier phase measurements, IEEE 802.11 WLAN RSSI, jitter, latency, network load, number of interrupts, out-of-order delivery, packet loss rate, packet error ratio (PER), packet reception rate (PRR), peak-to-average power ratio (PAPR), peak data rate, power histogram measurements, PSBCH-RSRP, PSSCH-RSRP, PSCCH-RSRP, received channel power indicator (RCPI), received interference power measurements, reference signal carrier phase (RSCP), RSCP difference (RSCPD), received signal code power, received signal to noise indicator (RSNI), received signal strength indicator (RSSI), reference signal time difference (RSTD), reference signal antenna relative phase (RSARP), reference signal received power (RSRP), RSRP per branch (RSRPB), reference signal received path power (RSRPP), reference signal received quality (RSRQ), reference signal (RS)-SINR, round trip time (RTT), (UE and/or RAN node) Rx-Tx measurements, (UE and/or RAN node) Rx-Tx time difference subframe offset, secondary synchronization signal (SSS) transmit power, SFN and frame timing difference (SFTD), signal-to-noise ratio (SNR), signal-to-noise and interference ratio (SINR), signal-plus-noise-plus-distortion to noise-plus-distortion (SINAD) ratio, SL AoA, SL CR, SL CBR, SL PRS-CR, SL PRS-CBR, SL PRS-RSRP, SL PRS-RSRPP, SL-RSRP, SL-RSRPP, SL RSSI, SL PRS-RSSI, SL-RSTD, SL Rx-Tx measurements, SL RTOA, SS-RSARP, SS-RSRP, SS-RSRQ, SS-SINR, SS-RSRPB, station (STA) statistics, transmission power, thermal noise power measurements, time domain channel property (TDCP), timing advance, UL AoA, UL RSCP, UL SRS-RSRP, UL SRS-RSRPP, UL RTOA, and/or other like measurements. Other measurements may be additionally or alternatively used, such as those discussed in [TS36214], [TS38215], 3GPP TS 38.314 (“[TS38314]”), 3GPP TS 28.552 (“[TS28552]”), 3GPP TS 32.425 (“[TS32425]”), IEEE 802.11, and/or the like. Additionally or alternatively, any of the aforementioned measurements (or combination of measurements) may be collected by one or more NANs 414 and/or other network nodes.

In some examples, a UE 402 can measure physical (e.g., DL, UL, and/or SL) signals using its Rx capabilities, such as by employing its radiofrequency (RF) frontend, digital baseband processing, and measurement algorithms (and using a measurement configuration) to gather information about the signal's characteristics. In these examples, the UE's 402 RF frontend receives signals transmitted by other network nodes (e.g., NANs 414 and/or other UEs 402 participating in the SL communication). The received signal is downconverted to baseband or an intermediate frequency suitable for digital processing. The downconverted signal is sampled and converted from analog to digital by the UE's 402 analog-to-digital conversion (ADC) circuitry, resulting in a digital representation of the received signal. The digital signal is processed by the UE's baseband processors (see e.g., processors 910 of FIG. 9) including tasks, such as filtering, synchronization, equalization, demodulation, and/or the like to extract useful information from the received signal. The UE 402 performs channel estimation by estimating various channel characteristics (e.g., path loss, fading, interference, and/or the like) based on the received signal and/or reference signals transmitted by neighboring UEs 402 and/or NAN(s) 414. Using the estimated channel characteristics, the UE 402 calculates measurements, such as any of the measurements discussed herein, and/or other metrics that characterize the quality of the received signals. The UE 402 may then report the measured parameters to the NW or neighboring UEs 402 using configured resources and/or as otherwise discussed herein.

As alluded to previously, the NG-RAN 404 provides a 5G-NR air interface (e.g., Uu interface), which may have the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH. The 5G-NR air interface may utilize BWPs for various purposes. For example, BWP can be used for dynamic adaptation of the SCS. For example, the UE 402 can be configured with multiple BWPs where each BWP configuration has a different SCS. When a BWP change is indicated to the UE 402, the SCS of the transmission is changed as well. Another use case example of BWP is related to power saving. In particular, multiple BWPs can be configured for the UE 402 with different amount of frequency resources (e.g., PRBs) to support data transmission under different traffic loading scenarios. A BWP containing a smaller number of PRBs can be used for data transmission with small traffic load while allowing power saving at the UE 402 and in some cases at the gNB 414a. A BWP containing a larger number of PRBs can be used for scenarios with higher traffic load.

The NG-RAN 404 may utilize one or more positioning methods in order to determine the position of a UE 402. Positioning the UE 402 (e.g., determining the position of a UE 402) involves two main operations: signal measurements and position estimate and optional velocity computation based on the measurements. The signal measurements may be made by the UE 402 and/or by the serving ng-eNB 414b or gNB 414a. The basic signals measured for terrestrial position methods are typically LTE or NR radio transmissions; however, other methods may make use of other transmissions, such as general radio navigation signals including those from Global Navigation Satellites Systems (GNSSs). The positioning function is not limited to a single method or measurement, and other methods and measurements that are available and appropriate can be used to meet the service needs of the location service (LCS) client 480. This additional information could include readily available E-UTRAN or NG-RAN measurements. The position estimate computation may be made by the UE 402 and/or by the LMF 470. UE positioning methods using SL may be used to obtain absolute position, relative position, or ranging information when the UE 402 is inside or outside NG-RAN coverage.

The RAN 404 is communicatively coupled to CN 440 that includes network elements and/or network functions (NFs) to provide various functions to support data and telecommunications services to customers/subscribers (e.g., UE 402). The components of the CN 440 may be implemented in one physical node or separate physical nodes. In some examples, NFV may be utilized to virtualize any or all of the functions provided by the network elements of the CN 440 onto physical compute/storage resources in servers, switches, and the like. A logical instantiation of the CN 440 may be referred to as a network slice, and a logical instantiation of a portion of the CN 440 may be referred to as a network sub-slice.

In the example of FIG. 4, the CN 440 is a 5GC 440 including an Authentication Server Function (AUSF) 442, Access and Mobility Management Function (AMF) 444, Session Management Function (SMF) 446, User Plane Function (UPF) 448, Network Slice Selection Function (NSSF) 450, Network Exposure Function (NEF) 452, Network Repository Function (NRF) 454, Policy Control Function (PCF) 456, Unified Data Management (UDM) 458, Unified Data Repository (UDR), Application Function (AF) 460, and Network Data Analytics Function (NWDAF) 462 coupled with one another over various interfaces as shown. Various aspects of the various NFs in the 5GC 440 are discussed in detail in '719 and [TS23501], among many other 3GPP standards/specifications. Although not shown by FIG. 4, the system 400 may also include NFs that are not shown such as, for example, any of those discussed in [TS23501]

The data network (DN) 436, at least in some examples, is a network hosting data-centric services such as, for example, operator services, the internet, third-party services, or enterprise networks. In some examples, the DN 436 includes one or more service networks that belong to an operator or third party, which are offered as a service to a client or UE 402. Additionally or alternatively, the DN 436 is provided by one or more servers including, for example, application (app)/content server 438, edge servers and/or edge compute nodes, cloud computing services, and/or the like. The DN 436 may be an operator external public, a private packet data network (PDN), or an intra-operator PDN, for example, for provision of IMS services. In this example, the app server 438 can be coupled to an IMS via an S-CSCF or the I-CSCF. In some implementations, the DN 436 may represent one or more local area DNs (LADNs), which are DNs 436 (or DN names (DNNs)) that is/are accessible by a UE 402 in one or more specific areas. Outside of these specific areas, the UE 402 is not able to access the LADN/DN 436. Additionally or alternatively, the DN 436 may be an edge DN 436, which is a (local) DN that supports the architecture for enabling edge applications. In these examples, the app server 438 may represent the physical hardware systems/devices providing app server functionality and/or the application software resident in the cloud or at an edge compute node that performs server function(s). In some examples, the app/content server 438 provides an edge hosting environment that provides support required for Edge Application Server's execution.

In some examples, the 5GS can use one or more edge compute nodes to provide an interface and offload processing of wireless communication traffic. In these examples, the edge compute nodes may be included in, or co-located with one or more RANs 404 or RAN nodes 414. For example, the edge compute nodes can provide a connection between the RAN 404 and UPF 448 in the 5GC 440. The edge compute nodes can use one or more NFV instances instantiated on virtualization infrastructure within the edge compute nodes to process wireless connections to and from the RAN 404 and UPF 448. The edge compute nodes may include or be part of an edge system that employs one or more edge computing technologies (ECTs) (also referred to as an “edge computing framework” or the like). The edge compute nodes may also be referred to as “edge hosts” or “edge servers.” The edge system includes a collection of edge servers and edge management systems (not shown) necessary to run edge computing applications within an operator network or a subset of an operator network. The edge servers are physical computer systems that may include an edge platform and/or virtualization infrastructure, and provide compute, storage, and network resources to edge computing applications. Each of the edge servers are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to UEs 402. The VI of the edge compute nodes provide virtualized environments and virtualized resources for the edge hosts, and the edge computing applications may run as VMs and/or application containers on top of the VI. Examples of the edge computing frameworks/ECTs and services deployment examples that can be used are discussed in '719.

The interfaces of the 5GC 440 include reference points and service-based interfaces. A reference point, at least in some examples, is a point at the conjunction of two non-overlapping functional groups, elements, or entities. The reference points in the 5GC 440 include: N1, N2, N3, N4, N5, N6, N7, N8, N9, N10, N11, N12, N13, N14 (between two AMFs 444; not shown), N15, N16, and N22. Other reference points not shown in FIG. 4 can also be used, such as any of those discussed in [TS23501]. The service-based representation of FIG. 4 represents NFs within the control plane that enable other authorized NFs to access their services. A service-based interface (SBI), at least in some examples, is an interface over which an NF can access the services of one or more other NFs. In some implementations, the service-based interfaces are API-based interfaces (e.g., HTTP/2, RESTful, SOAP, and/or any other API or web service) that can be used by an NF to call or invoke a particular service or service operation. The SBIs in the 5GC 440 include: Namf, Nsmf, Nnef, Npcf, Nudm, Naf, Nnrf, Nnssf, Nausf. Other service-based interfaces (e.g., Nudr, N5g-eir, and Nudsf) not shown in FIG. 4 can also be used, such as any of those discussed in [TS23501].

FIG. 5 depicts an example UE positioning architecture sp00 that is applicable to NG-RAN. The UE positioning architecture sp00 is an architecture in a 5GS applicable to positioning of a UE 402 with NR and/or E-UTRA access. The positioning architecture sp00 also supports the NR PC5 interface. SL positioning can be supported when the UE 402 is inside NG-RAN coverage (e.g., UE 402-A and UE 402-B) and when the UE 402 is outside NG-RAN coverage (e.g., UE 402-C and UE 402-D).

The AMF 444 receives a request for some location service associated with a particular target UE from another entity (e.g., GMLC or UE) or the AMF 444 itself decides to initiate some location service on behalf of a particular target UE 402t (e.g., for an IMS emergency call from the UE 402) as described in 3GPP TS 23.502 (“[TS23502]”) and 3GPP TS 23.273 (“[TS23273]”).

The AMF 444 then sends a location services request to an LMF 470. The LMF 470 processes the location services request which may include transferring assistance data to the target UE to assist with UE-based and/or UE-assisted positioning and/or may include positioning of the target UE 402t. The LMF 470 then returns the result of the location service back to the AMF 444 (e.g., a position estimate for the UE 402. In the case of a location service requested by an entity other than the AMF 444 (e.g., a GMLC 472 or UE 402), the AMF 444 returns the location service result to this entity.

An LMF 470 may have a proprietary signaling connection to an Enhanced Serving Mobile Location Center (E-SMLC) 515 which may enable an LMF 470 to access information from E-UTRAN (e.g., to support the observed time difference of arrival (OTDOA) for E-UTRA positioning method using downlink measurements obtained by a target UE of signals from eNBs and/or PRS-only TPs in E-UTRAN). Details of the signalling interaction between an LMF 470 and E-SMLC 515 may be defined in suitable specifications/standards, may be implementation-specific, and/or may involve proprietary signaling.

An LMF 470 may have a proprietary signalling connection to an SUPL Location Platform (SLP) 510. The SLP 510 is the Secure User Plane Location (SUPL) entity responsible for positioning over the user plane. Further details of user-plane positioning are provided in Secure User Plane Location Architecture, Approved Version 2.0, OPEN MOBILE ALLIANCE (OMA), OMA-AD-SUPL-V2_0 (17 Apr. 2012), and UserPlane Location Protocol Approved, Approved Version 2.0.6, OPEN MOBILE ALLIANCE (OMA), OMA-TS-ULP-V2_0_6 (4 Aug. 2020). Details of the signaling interaction between an LMF 470 and SLP 510 may be defined in suitable specifications/standards, may be implementation-specific, and/or may involve proprietary signaling.

Individual NG-RAN nodes 414 may control one or several TRPs/transmission points (TPs), such as remote radio heads (RRHs) or DL-PRS-only TPs for support of PRS-based terrestrial beacon system (TBS). In case of split gNB architecture, a gNB-DU may include TRP functionality where the TRP functionality may support functions for a TP, RP or both TP and RP. A gNB-DU which includes TRP functionality does not need to offer cell services.

A gNB 414a provides measurement information for a target UE 402t and communicates this information to an LMF 470. To support NR RAT-dependent positioning, the gNB 414a may make measurements of radio signals for a target UE 402t, and provide measurement results for position estimation. A gNB 414a may serve several TRPs, including for example RRHs, and UL-SRS only RPs and DL-PRS-only TPs. For a non-terrestrial network (NTN), a TRP may be located on board the satellite. Additionally or alternatively, a gNB 414a may broadcast assistance data information, received from an LMF 470, in positioning System Information messages.

The ng-eNB 414b provides measurement results for position estimation, makes measurements of radio signals for a target UE 402t, and communicates these measurements to an LMF 470. The ng-eNB 414b makes its measurements in response to requests from the LMF 470 (on demand or periodically). An ng-eNB 414b may serve several TPs, including for example RRHs and PRS-only TPs for PRS-based TBS positioning for E-UTRA. An ng-eNB 414b may broadcast assistance data information, received from an LMF, in positioning system information messages.

The UE 402 may make measurements of downlink signals from NG-RAN 404, SL signals from other UEs 402, other sources such as E-UTRAN, different GNSS and TBS systems, WLAN access points, Bluetooth beacons, UE barometric pressure and motion sensors, and/or the like. The measurements to be made are determined by the chosen positioning method.

The UE 402 may also contain LCS applications, or access an LCS application either through communication with a network accessed by the UE 402 or through another application residing in the UE 402. This LCS application may include the needed measurement and calculation functions to determine the UE's position with or without network assistance. This is outside of the scope of this specification.

The UE 402 may also, for example, contain an independent positioning function (e.g., GPS) and thus be able to report its position, independent of the NG-RAN transmissions. The UE with an independent positioning function may also make use of assistance information obtained from the NW.

For the 3GPP 5GS control plane solution defined in [TS23501], [TS23502], and [TS23273], the UE 402 is the target device and the LMF 470 is the server. For SUPL 2.0 support, the SUPL Enabled Terminal (SET) is the target device and the SLP 510 is the server. The operations controlled through LPP are described further in [TS38305] § 7.1.

A positioning reference unit (PRU) at a known location can perform positioning measurements (e.g., RSTD, RSRP, UE Rx-Tx Time Difference measurements, DL-RSCPD, DL-RSCP, and/or the like) and report these measurements to a location server. In addition, the PRU can transmit SRS to enable TRPs to measure and report UL positioning measurements (e.g., RTOA, UL-AoA, gNB Rx-Tx Time Difference, UL-RSCP, and/or the like) from PRU at a known location. The PRU measurements can be compared by a location server with the measurements expected at the known PRU location to determine correction terms for other nearby target devices. The DL- and/or UL location measurements for other target devices can then be corrected based on the previously determined correction terms. PRU measurements may also be provided to the target device in the assistance data as described in [TS38305] § 8.12. From a location server perspective, the PRU functionality is realized by a UE 402 with known location.

The SL positioning protocol (SLPP) and/or ranging/SL positioning protocol (RSPP) is exchanged over PC5-U reference point between UEs 402 (e.g., target UE 402t, anchor UE 402, server UE 402) to manage RSP sessions among a group of UEs 402. SLPP is also exchanged between a target UE 402t and a LMF 470 to support SL positioning. In this case, the SLPP messages are carried as transparent PDUs across intermediate network interfaces using the appropriate protocols (e.g., NGAP over the NG-C interface, NAS/RRC over the NR-Uu interface). SLPP enables SLPR using a multiplicity of different position methods, while isolating the details of any particular positioning method and the specifics of the underlying transport from one another. SLPP is used point-to-point between endpoints (e.g., server and target) in order to obtain absolute position, relative position, or ranging information of target UE 402t using SL measurements obtained by one or more reference sources (e.g., see e.g., [TS38355], [TS38305], and [TS23273]).

An SLPP session is used between UEs 402 or between a UE 402 and an LMF 470 to fulfil an RSP service request and/or in order to obtain location related measurements based on NR PC5 radio signals, a location estimate, or to transfer assistance data. A single SLPP session is used to support a single location request (LR) (e.g., for a single SL-mobile terminated (MT)-LR or SL-mobile originated (MO)-LR). Multiple SLPP sessions can be used between the same endpoints to support multiple different location requests (see e.g., [TS23273]). A UE 402 may simultaneously participate in multiple SLPP sessions.

Each SLPP session comprises one or more SLPP transactions, with each SLPP transaction performing a single operation (e.g., capability exchange, assistance data transfer, location information transfer, and/or the like). The SLPP transactions are realized as SLPP procedures. The instigator of an SLPP session instigates the first SLPP transaction, but subsequent transactions may be instigated by either end (or endpoint). SLPP transactions within a session may occur serially or in parallel. SLPP transactions are indicated at the SLPP protocol level with a transaction identifier (ID) in order to associate messages with one another (e.g., request and response). Messages within a transaction are linked by a common transaction ID and/or session ID.

For UE-only operation, the instigator of an SLPP session, which is the endpoint who receives an LCS request (or SLPP request), initiates an SLPP session by sending an SLPP message containing an assigned (SLPP) session ID to the other endpoint(s). All constituent messages within a session contain the same session ID. For UE-only scenarios, an (SLPP) session ID is used to identify all SLPP transactions belonging to an SLPP session, which enables UEs 402 to uniquely distinguish SLPP messages for one session from SLPP messages for other sessions.

For LMF-involved operation, the session ID is assigned by the target UE 402t and contained in the SLPP messages used for communication between UEs 402. The (SLPP) session ID may be included in the SLPP message for the communication between target UE 402t and the LMF 470. For LMF-involved cases, the (SLPP) session ID is assigned by the SL target UE 402t and used for SLPP messages exchanged between the group of UEs 402. Additionally or alternatively, for LMF-involved cases, the SLPP session ID is optionally included in SLPP messages transferred between SL target UE and LMF 470.

SLPP operates on a transaction basis between UEs 402 and between a UE 402 and an LMF 470, with each transaction taking place as an independent procedure as described in [TS38355]. More than one such procedure may be in progress at any given moment. An SLPP procedure may involve a request/response pairing of messages or one or more “unsolicited” messages. Each procedure has a single objective (e.g., transfer of assistance data, exchange of SLPP related capabilities, positioning/ranging of a target device according to some QoS and use of one or more SL positioning methods, and/or the like). Multiple procedures, in series and/or in parallel, can be used to achieve more complex objectives (e.g., positioning of a target device in association with transfer of assistance data and exchange of SLPP related capabilities).

Each SLPP transaction involves the exchange of one or more SLPP messages between at least two endpoints. The general format of an SLPP message includes a set of common fields followed by a body. The body (which may be empty) contains information specific to a particular message type. Each message type contains information specific to one or more positioning methods (e.g., SL-TDOA, SL-TOA, SL-AoA, and/or SL-RTT) and/or information common to all positioning methods. As examples, the fields common to some or all SLPP messages include: session ID (identifies messages belonging to the same session); transaction ID (identifies messages belonging to the same transaction); transaction end flag (indicates when a transaction (e.g., one with periodic responses) has ended); sequence number (enables detection of a duplicate SLPP messages at a receiver); acknowledgement (ACK) (enables an acknowledgement to be requested and/or returned for any SLPP message). As examples, the following SLPP message types can be defined: request capabilities; provide capabilities; request assistance data; provide assistance data; request location information; provide location information; abort; and error.

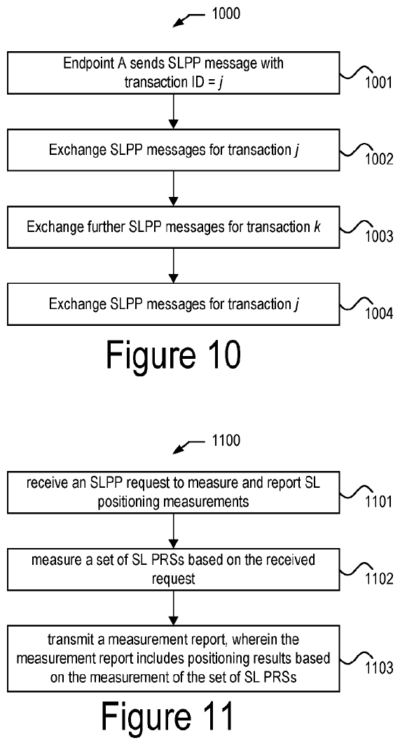

FIG. 10 shows an example SLPP session procedure 1000, which may be performed by an endpoint A and endpoint B. The SLPP session procedure 1000 can be used to support an SLPP session comprising a sequence of SLPP transactions. The SLPP session procedure 1000 includes operation 1001 where endpoint A, which is the Endpoint who receives the LCS/SLPP request, initiates an SLPP session by sending an SLPP message containing an assigned session ID for an initial SLPP transaction j (transaction ID=j) to the other endpoint B. At operation 1002, endpoints A and B exchange further messages to continue the transaction started in operation 1001, wherein each of these messages contains the transaction ID=j. At operation 1003, either endpoint may instigate further transactions by sending additional SLPP messages (e.g., with transaction ID=k). At operation 1004, the session is terminated by a final transaction N in which SLPP messages will be exchanged between the two endpoints (e.g., with transaction ID=N).

Within the same session, all constituent messages contain the same session ID and within each transaction, and all constituent messages also contain the same transaction ID. The last message sent in each transaction includes the IE endTransaction set to ‘TRUE’. Transactions that occur in parallel use different transaction IDs; transaction IDs for completed transactions may be reused at any time after the final message of the previous transaction with the same ID is known to have been received. Additionally, any of the messages discussed w.r.t FIG. 10 may be any type of SLPP message, such as request/provide capabilities messages, request/provide assistance data messages, request/provide location information messages, abort messages, and/or error messages.

The capabilities messages may be used during an SLPP capabilities transfer procedure. Capabilities in an SLPP context refer to the ability to support different SLPP/SLPR positioning methods (e.g., SL-RTT, SL-TDOA, SL-AOA, SL-TOA, SL-RSTD, SL-RSRP, SL-RSRPP, SL-Rx-Tx time difference, SL-RTOA), different aspects of a particular positioning method (e.g., different types of measurements or assistance data) and common features not specific to only one positioning method. The exchange of capabilities between different endpoints may be initiated by a request or sent as unsolicited information (e.g., without a request). In the example of FIG. 10, when the request method is used, endpoint A may send an SLPP request capabilities message to endpoint B with a request for capability information, and the endpoint B responds by sending an SLPP provide capabilities message to endpoint A. The SLPP provide capabilities message includes or indicates the capabilities (positioning methods) supported by endpoint B. The capabilities may refer to particular position methods or may be common to multiple position methods.

The assistance data messages may be used during an SLPP assistance data transfer procedure. Assistance data may comprise SL-PRS information (e.g., SL-PRS sequence ID, measurement reports, and/or the like) or position calculation information (e.g., SL anchor UE location information, and/or the like) and may be transferred either by request or unsolicited. Additionally or alternatively, examples of the assistance data that may be transferred between endpoints includes assistance information common to all positioning methods (e.g., application layer ID identifying a UE 402 as defined in [TS23287], SL-PRS sequence ID as defined in [TS38211], antenna reference point (ARP) ID identifying an SL-PRS Tx ARP associated with a UE 402, anchor UE location coordinates, and SL-PRS Tx ARP location coordinates), SL-RTT assistance information (e.g., the common assistance information), SL-AoA assistance information (e.g., the common assistance information and expected AoA uncertainty), SL-TDOA assistance information (e.g., the common assistance information and synchronization information between anchor UEs), and/or SL-TOA assistance information (e.g., the common assistance information and synchronization information between anchor UEs).

In the example of FIG. 10, when the request method is used for the SLPP assistance data transfer procedure, endpoint A may send an SLPP request assistance data message to endpoint B indicating that assistance data is needed, and the endpoint B responds by sending an SLPP provide assistance data message to endpoint A. The SLPP provide assistance data message includes or indicates the assistance data requested by endpoint A. In some examples, endpoint B may transfer additional assistance data to endpoint A in one or more additional SLPP messages.

The location information messages may be used during an SLPP location information transfer procedure. The term “location information” applies both to an actual position estimate and to values used in computing position (e.g., SL-PRS measurements and/or the like). Location information can be delivered either in response to a request or unsolicited. In the example of FIG. 10, when the request method is used, endpoint A may send an SLPP request location information message to endpoint B indicating the type of location information needed and associated QoS (if any). In response, endpoint B transfers the requested location information to endpoint A in an SLPP provide location information message. Optionally (e.g., if requested in step 1), endpoint B may transfer additional location information to endpoint A in one or more additional SLPP messages.

Examples of the location request information that may be transferred between endpoints includes location request information common to all positioning methods (e.g., requested location information type (e.g., location estimate, location measurements, range estimate, range measurements), periodic reporting criteria, positioning QoS (e.g., desired horizontal/vertical accuracy, desired range accuracy, response time, velocity request), environment information (e.g., expected multipath and non line of sight (NLOS) in the current area), scheduled location time, and requested measurement information (e.g., LOS-NLOS indicator request, SL-PRS-RSRP request, first path SL-PRS-RSRPP request, and additional paths request)), SL-RTT location information (e.g., the common location request information with additional requested measurement information including ARP information request, timing quality request, multiple SL-PRS Rx-Tx time differences request, and/or associated SL-PRS Tx time stamp request), SL-AoA location information (e.g., the common location request information), SL-TDOA location information (e.g., the common location request information with additional requested measurement information including ARP information request and SL timing quality request), and/or SL-TOA location information (e.g., the common location request information with additional requested measurement information including ARP information request and SL timing quality request).

Additionally or alternatively, examples of the location result information that may be transferred between endpoints includes SL-RTT location result information (e.g., location estimate, range estimate, velocity estimate, and SL-RTT measurement information (e.g., LOS-NLOS indicator, ARP ID, SL-PRS resource ID, SL-PRS Rx-Tx time difference measurement(s), SL-PRS-RSRP measurement, SL-PRS first path RSRPP measurement, additional paths measurement, timestamp of measurements, timing quality of measurements, and SL-PRS Tx time information)), SL-AoA location result information (e.g., location estimate, direction estimate, velocity estimate, and SL-AoA measurement information (e.g., LOS-NLOS indicator, angle quality of measurements, additional paths angle measurement, azimuth/elevation measurement, azimuth/elevation LCS to GCS transformation parameter, ARP ID, SL-PRS resource ID, SL-PRS-RSRP measurement, SL-PRS first path RSRPP measurement, additional paths measurement, and timestamp of measurements)), SL-TDOA location result information (e.g., location estimate, velocity estimate, and SL-TDOA measurement information (e.g., LOS-NLOS indicator, ARP ID, SL-PRS resource ID, SL-PRS-RSRP measurement, SL-PRS first path RSRPP measurement, additional paths measurement, timestamp of measurements, and timing quality of measurements)), and SL-TOA location result information (e.g., location estimate, velocity estimate, and SL-TDOA measurement information (e.g., LOS-NLOS indicator, SL-RTOA measurement, ARP ID, SL-PRS resource ID, SL-PRS-RSRP measurement, SL-PRS first path RSRPP measurement, additional paths measurement, timestamp of measurements, and timing quality of measurements)).

The error messages may be used during an SLPP error handling procedure, which is used to notify a sending endpoint (e.g., endpoint A) by the receiving endpoint (e.g., endpoint B) that an SLPP message sent by the sending endpoint (e.g., endpoint A) is erroneous or unexpected.

The abort messages may be used during an SLPP abort procedure, which is used to notify another endpoint by one endpoint to abort an ongoing SLPP procedure (or SLPP session) between the two endpoints. For example, during an ongoing SLPP procedure between the endpoints A and B in FIG. 10, if endpoint B determines that the procedure should be aborted, endpoint B sends an SLPP abort message to the endpoint A carrying the transaction ID for the procedure.

The SLPP procedures are not required to occur in any fixed order, in order to provide greater flexibility in positioning. Even with the flexibility allowed by SLPP, in some examples the SLPP procedures may occur in the following order: (1) capability transfer; (2) assistance data transfer; and (3) location information transfer (measurements and/or location estimate).

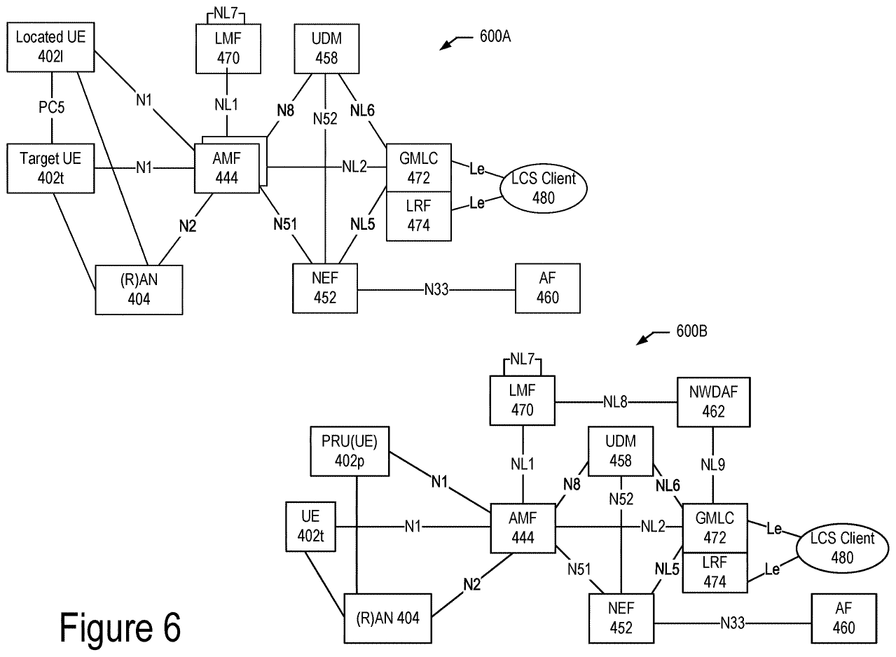

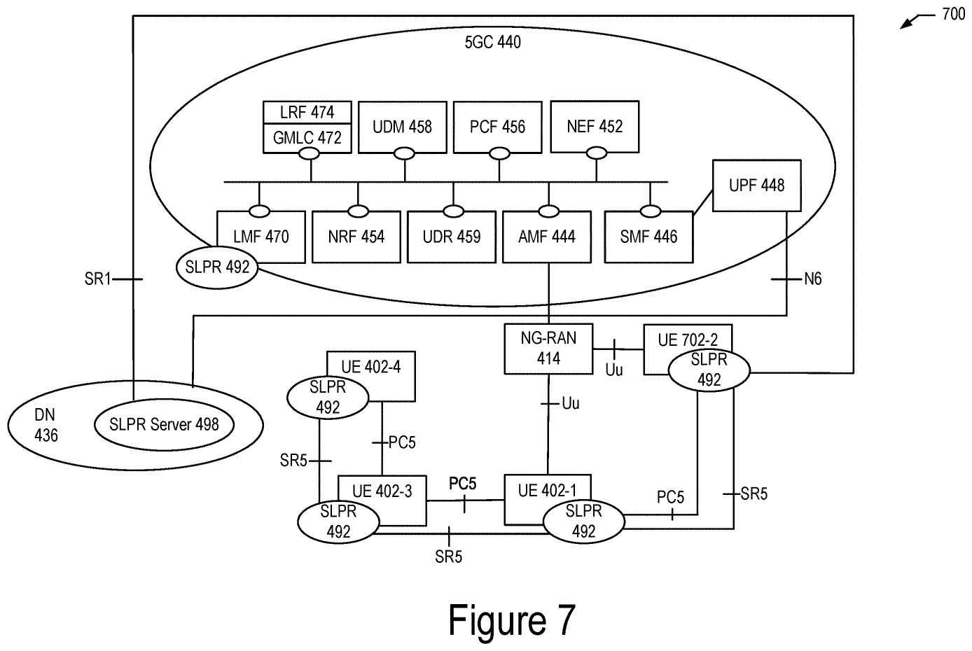

FIG. 6 depicts an example network assisted SL positioning architecture 600A and an example Location Services (LCS) reference architecture 600B in reference point representation; and FIG. 7 depicts an example reference architecture 700 for SLPR-based services.

FIGS. 6 and 7 include a located UE 402l, anchor UE 402a, and/or PRU 402p realized by a UE 402 as defined in 3GPP TS 38.305 (“[TS38305]”) § 5.4.5; a target UE 402t, a RAN 404, various NFs, a Location Management Function (LMF) 470, a Gateway Mobile Location Centre (GMLC) 472, a Location Retrieval Function (LRF) 474, an LCS client 480, among other elements discussed infra. The SLPR aspects are discussed in [TR38845] and [TS23273]. Network assisted SL positioning allows a target UE 402t to obtain its location by relative position with a located UE 402l and the located UE's 402l location.

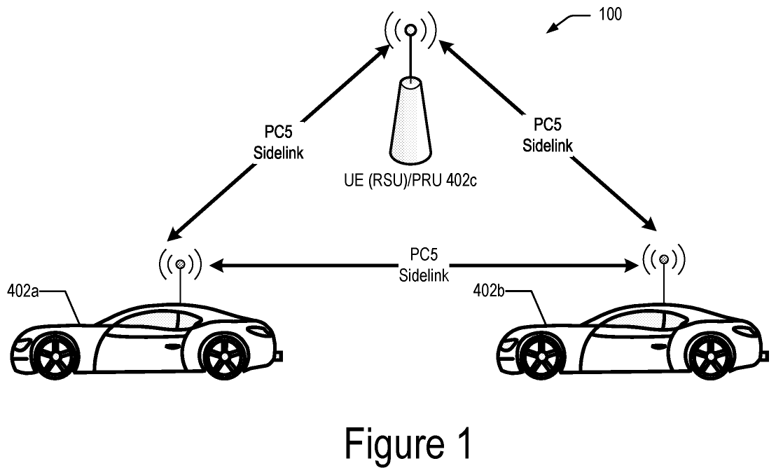

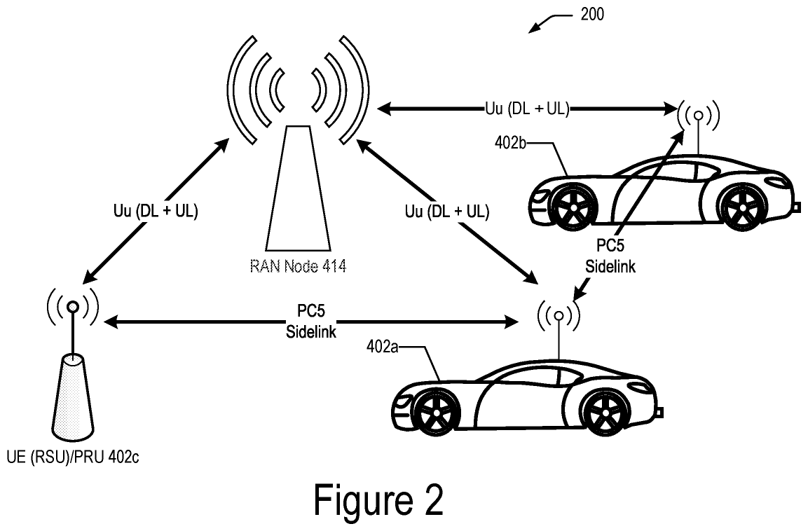

The various UEs 402 discussed herein and shown by FIGS. 1-wp may be 5G ProSe-enabled UEs (5PUEs) that support 5G ProSe requirements, operations, and associated procedures as discussed in 3GPP TS 23.304 (“[TS23304]”) and 3GPP TS 23.303 (“[TS23303]”). In some examples, a 5PUE 402 can act as a 5G ProSe UE-to-UE Relay and/or act as a 5G ProSe UE-to-Network Relay that provides functionality to support connectivity to the NW and/or DN 436 for one or more 5G ProSe Remote UEs. In some examples, the SLPR mechanisms discussed herein can include ProSe direct discovery (including Model A and Model B discovery) and the various procedures discussed in [TS23586] and/or the like. Additionally or alternatively, the SLPR server 498 in FIG. 7 may be or act as a ProSe application (app) server 438 as discussed [TS23304] and/or [TS23303].

The access network (e.g., RAN 404) is involved in the handling of various SL positioning procedures (e.g., including the SL positioning methods discussed herein) including positioning of a target UE 402t, provision of location related information not associated with a particular target UE 402t and transfer of positioning messages between an AMF 444 or LMF 470 and a target UE 402t. The access network supports determination of location estimates in geographical and/or local co-ordinates as defined in [TS23032]. The LCS specific functionalities of the RAN elements are specified in [TS38305] for NG-RAN 404.

AFs 460 and NFs may access LCS services from the GMLC 472 in the same trust domain (e.g., in the same PLMN) using the Ngmlc interface or Event Exposure with location information from an AMF 444 in the same trust domain using the Namf interface. The NWDAF 462 collects UE location information by accessing the GMLC 472 directly. The LCS clients 480 may access LCS services from the GMLC 472 (e.g., H-GMLC) using the Le reference point. External AFs 460 may access LCS services from an NEF 452 using the Nnef interface or CAPIF API. The CAPIF and associated API provider domain functions are specified in [TS23222]. An LCS client 480 or AF 460 may access LCS services from a UE 402 over a user plane connection for reporting of location events by the UE 402 for a periodic or triggered 5GC-MT-LR when the UE is able to determine location estimates.

The GMLC 472 contains functionality required to support LCS. In one PLMN, there may be more than one GMLC 472. A GMLC 472 is the first node an external LCS client accesses in a PLMN (e.g., the Le reference point is supported by the GMLC 472). AFs 460 and NFs may access GMLC 472 directly or via the NEF 452. The GMLC 472 may request routing information and/or target UE 402t privacy information from the UDM 458 via the Nudm interface. After performing authorization of an external LCS Client 480 or AF 460 and verifying target UE 402t privacy, a GMLC 472 forwards a location request to either a serving AMF 444 using Namf interface or to a GMLC 472 in another PLMN using the Ngmlc interface in the case of a roaming UE 402. The target UE's 402t privacy profile settings is/are always checked in the UE's home PLMN prior to delivering a location estimate.

The LRF 474 may be collocated with a GMLC 472 or separate from the GMLC 472. The LRF 474 is responsible for retrieving or validating location information, providing routing and/or correlation information for a UE 402, which has initiated an IMS emergency session. The information is provided by an LRF 474 to an E-CSCF (see e.g., 3GPP TS 23.167).

The LMF 470 manages the overall co-ordination and scheduling of resources required for the location of a UE that is registered with or accessing 5GCN 440. It also calculates or verifies a final location and any velocity estimate and may estimate the achieved accuracy. The LMF 470 receives location requests for a target UE 402t from the serving AMF 444 using the NImf interface. The LMF 470 interacts with the UE in order to exchange location information applicable to UE assisted and UE based position methods and interacts with the NG-RAN 404, N3IWF or TNAN in order to obtain location information.

The LMF 470 determines the result of the positioning in geographical co-ordinates as defined in [TS23032] and/or in local co-ordinates as defined in [TS23032]. If requested and if available, the positioning result may also include the velocity of the UE 402. The coordinate type(s) is determined by LMF 470 when receiving a location request, based on LCS Client type and supported GAD shapes. If the location request indicates regulatory LCS client type the LMF 470 determines a geographical location and optionally a location in local coordinates. For location request indicates a value added LCS Client type, the LMF 470 may determine the UE location in local coordinates or geographical co-ordinates or both. If the supported GAD shapes is not received or Local Co-ordinates is not included in the supported GAD shapes, the LMF 470 determines a geographical location. Some RAT independent position methods (e.g., GNSS based position methods) can only determine a UE location in geographical co-ordinates. In such a case, the LMF 470 may translate a UE location in geographical co-ordinates into a location in local co-ordinates when an origin for the local co-ordinates has known global coordinates. When an origin for the local co-ordinates does not have known global coordinates, position methods that can only determine a UE location in geographical co-ordinates cannot be used to determine a UE location in local co-ordinates.

Additional functions which may be performed by an LMF 470 to support location services include the following: support a request for a single location received from a serving AMF 444 for a target UE 402t; support a request for periodic or triggered location received from a serving AMF 444 for a target UE 402t; determine type and number of position methods and procedures based on UE and PLMN capabilities, QoS, UE connectivity state per access type, LCS Client type, co-ordinate type and optionally service type and indication of requiring reliable UE location information; report UE location estimates directly to a GMLC 472 for periodic or triggered location of a target UE 402t; support cancelation of periodic or triggered location for a target UE 402t; support the provision of broadcast assistance data to UEs via NG-RAN 404 in ciphered or unciphered form and forward any ciphering keys to subscribed UEs via the AMF 444; support change of a serving LMF 470 for periodic or triggered location reporting for a target UE 402t; support of receiving stored UE Positioning Capability from AMF 444 and support of providing updated UE Positioning Capability to AMF 444; map the UE location to a geographical area where the PLMN is or is not allowed to operate based on the request from AMF 444; support determination of a UE location at a scheduled location time; determine whether to use user plane or control plane for positioning; support handling of 5GC-MT-LR, 5GC-NI-LR, 5GC-MO-LR and deferred 5GC-MT-LR for periodic or triggered location over a user plane connection between UE 402 and LMF 470; support collection of GNSS assistance data from AFs; and/or support service level PRU Association (e.g., a PRU association is an association of a PRU 402p with an LMF 470 by providing PRU related information to the LMF 470), PRU Association update or PRU Disassociation (e.g., LMF 470 supports verification of a PRU initiated Association or Disassociation by checking whether there is an PRU verified indication from AMF 444, LMF 470 stores the received PRU information contained in service level PRU Association message, LMF 470 may indicate support of PRU function to NRF via NF profile and may further send the PRU information to NRF via NF profile update, and LMF 470 may request a PRU 402p to associate to a new LMF 470 by returning a Routing ID of the new LMF 470); support selection of a PRU 402p based on stored PRU information if the LMF 470 needs to obtain the location measurements from the PRU 402p to assist positioning of a target UE 402t; support to obtain PRU location measurements as described in [TS38305] § 5.4.5 by triggering the procedure in [TS23273] § 6.11. support to obtain PRU location measurements from other PRU serving LMF(s) 470 (e.g., as a serving LMF 470 of target UE(s) 402t, support discovery and selection of other PRU serving LMF(s) 470 by querying the NRF and support to request PRU location measurements from the selected LMF(s) 470. As a serving LMF 470 of PRU(s) 402p, support to provide PRU location measurements to other LMF(s) 470 after receiving a request from other LMF(s) 470); support to determine UE location by considering obtained PRU location measurements; support a request for user plane reporting from a UE to an LCS client 480 or AF 460 for a periodic or triggered 5GC-MT-LR. Subsequently, support the transfer of cumulative event reports from the target UE 402t via control plane back to the H-GMLC 472 and LCS client 480 or AF 460. Also support any request for assistance data received in a cumulative event report; and determine UE location for a UE connecting to a MBSR based on location and velocity of the MBSR and the timing of the location estimations for the target UE 402t and MBSR.

In addition to the functions defined in [TS23273], the LMF 470 supports the following functionality: the network based SL positioning and network assisted SL positioning: trigger RSP, exchange the RSP capability, exchange the RSP assistant data, exchange RSP signal measurement data/result. support of receiving stored RSP capability from AMF 444 and support of providing updated RSP capability to AMF 444, determine RSP method based on the positioning QoS requirement and/or UE's RSP capability, determine the required QoS for Located UE positioning, optionally determine the same scheduled location time for the RSP and the positioning of the located UE(s) 402 in case if the scheduled location time is absent, determine the location of the target UE 402t based on the Ranging/SL positioning measurement data or result reported by target UE 402t and the location of located UE(s) 402, and interaction with GMLC 472 to get the location of located UE 402l/SL reference UE 402 using the application layer ID; and delivering the RSP service request/response for the ranging service exposure to UE 402.

An RSP service request can be initiated by a UE 402 (e.g., an SL positioning client UE 402, target UE 402t, SL reference UE 402, and/or the like), a 5GC NF, an LCS client 480, or an AF 460. When a direct RSP between an SL reference UE 402 and a target UE 402t cannot be supported, RSP between an SL reference UE 402 and a target UE 402t over the PC5 interface may use assistance of another UE 402.

The RSP service request includes the identifiers of the two or more UEs 402. When the service exposure is via 5GC 440, the GMLC 472 translates the target UE's identifiers (e.g., in the RSP service request) into a subscription permanent identifier (SUPI). When the service exposure is via PC5 or through 5GC user plane, the identifiers can be RSP application specific application layer IDs.

The RSP service request can also include the required QoS, the required location results (e.g., absolute locations, relative locations or distances, and/or directions related to the UEs ys02 as defined in [TS23586] § 4.4). Additionally or alternatively, the RSP service request can include periodic or trigger event parameters such as, for example, the time interval between successive location reports and the total number of reports, the trigger events, the duration of event reporting, the minimum and maximum time intervals between successive event reports, the maximum event sampling interval, whether location estimates shall be included in event reports, and whether only one location report is required or more than one. As examples, trigger events can be the relative position/distance between at least one pair of UEs of the indicated UEs is less than the threshold; the relative position/distance between at least one pair of UEs of the indicated UEs exceeds the threshold; the relative positions/distances between all UEs are less than the threshold; and/or the relative positions/distances between all UEs exceed the threshold.

In addition to the functions defined in [TS23273], the GMLC 472 supports the following functionality: enable trusted AFs and NFs to perform MT-LR by accessing GMLC 472 directly with additional service parameters for RSP; enable AFs 460 and NFs to perform MT-LR by accessing GMLC 472 through NEF 452 with additional service parameters for RSP; determine the serving AMF instances for the UEs 402 involved in the RSP request and forward the request to respective serving AMF 444; receive response from AMF 444 and event reports from and return RSP result to NFs and AFs 460; and perform application layer ID to GPSI or GPSI to application layer ID resolution by querying NEF 452.

In addition to the functionality discussed herein and in [TS23501], the AMF 444 contains functionality responsible for managing positioning for a target UE 402t for all types of location request. The AMF 444 is accessible to the GMLC 472 and NEF 452 via the Namf interface, to the RAN 404 via the N2 reference point and to the UE 402 via the N1 reference point. Functions which may be performed by an AMF 444 to support location services include the following: initiate an NI-LR location request for a UE 402 with an IMS emergency call or to know a UE geographical area with NR satellite access for PLMN selection verification; receive and manage location requests from a GMLC 472 for a 5GC-MT-LR and deferred 5GC-MT-LR for periodic, triggered and UE available location events; receive and manage location requests from a UE for a 5GC-MO-LR; receive and manage Event Exposure request for location information from an NEF 452; select an LMF 470; receive updated privacy requirements from a UE and transfer to a UDR 459 via UDM 458; support cancelation of periodic or triggered location reporting for a target UE 402t; support change of a serving LMF 470 for periodic or triggered location reporting for a target UE 402t; when assistance data is broadcast by 5GS in ciphered form, the AMF 444 receives ciphering keys from the LMF 470 and forwards to suitably subscribed UEs 402 using mobility management procedures; store UE Positioning Capability received from an LMF 470 and send the UE Positioning Capability along with the received location request to an LMF 470; receive UL NAS Transport including a PRU Association, Association Update, or Disassociation Request (contained in an LCS supplementary service message) from a UE 402; the AMF 444 may verify whether a UE can serve as a PRU 402p based on UE subscription data after receiving the PRU Association Request, Association Update, or Disassociation. AMF 444 may also use local policy to determine if UEs are allowed to serve as a PRU 402p; sends the PRU Association Request or PRU Disassociation Request to LMF 470 and may include a UE verification indication indicating whether this UE is authorized to serve as a PRU 402p; support triggering LMF 470 to establish a User Plane Connection to UE if UE requested that; store in UE context that UE has a maintained User Plane connection with certain LMFs 470 (details of UE Positioning Capability is defined in 3GPP TS 37.355); support of local configuration of a mapping table of UE identifier ranges and LMF 470 identifier(s) or querying the UDM 458 the LMF 470 identifier for a UE for a 5GC-MO-LR; and/or supports the 5G to EPS Handover by providing the target MME ID to GMLC 472 as part of the LCS Service response.

In addition to the functionality discussed herein and in [TS23501], the UDM 458 contains LCS subscriber and LCS privacy profile and routing information. The UDM 458 is accessible from an AMF 444, GMLC 472 or NEF 452 via the Nudm interface. The UDM 458 may also contain an indication whether a UE 402 is allowed to serve as a PRU 402p as part of the UE subscription data. The UDM 458 may also contain LMF identifier(s) in UE LCS subscription data. In addition to the functionality discussed herein and in [TS23501], the UDR 459 contains privacy data information for target UEs 402t and may be updated by a serving AMF 444 via UDM 458 with new privacy information received from a UE 402.

In addition to the functionality discussed herein and in [TS23501], the NEF 452 provides a means of accessing location services by an external AF 460 or internal AF 460. AFs 460 access location services from an NEF 452 using an API. Depending on QoS requirements, an NEF 452 can forward a location request to a GMLC 472 or request an event exposure for location information from serving AMF 444 (optionally via a UDM 458). When event exposure via AMF 444 is used, an NEF 452 may request routing information and/or target UE privacy information from the UDM 458 via the Nudm interface. Additional functions which may be performed by an NEF 452 to support location services include the following: support location requests from an AF for immediate location and for deferred periodic and triggered location events; support location information exposure to an AF 460 based on the location request; support determination of GMLC 472 or AMF 444 based on, for example, the QoS requirements from the AF 460, type of the location request; select the serving AMF 444 for a target UE 402t when there is more than one serving AMF 444; determine whether to attempt a second location request for a target UE 402t from a different AMF 444 when location information returned by a first AMF 444 does not meet QoS requirements and there is more than one serving AMF 444; support UE LCS privacy profile provision from the AF 460; support suspending and cancellation of a periodic or triggered location request; support authorization of LCS request from the AF 460; support rejecting the LCS request coming from an AF 460, for example, when the number of target UEs 402 in the LCS request exceeds the maximum target UE number of such client; and/or support allocating the reference number for each location request from an AF 460 for LDR. In some examples, if the GMLC 472 or AMF 444 are determined based on the QoS requirements and the QoS requirements include multiple QoS class, the determination of GMLC 472 or AMF 444 is done based on the most stringent (e.g., primary) QoS requirements.

SLPR-based services are supported based on the architecture in FIG. 7, with the following reference points: The SR1 reference point is between the UE SLPR function 492 in the UE 402 and the SLPR server 498. The SR1 reference point may be used for configuration, application layer signaling, and/or the like. The SR5 reference point is between individual SLPR functions 492 in respective UEs 402. The SR5 reference point is carried over the PC5 interface/reference point (e.g., SR5 may be over PC5-RRC, PC5-D, PC5-U, and/or PC5-S reference points). The PC5 reference point is between individual UEs 402, and also supports various SLPR operations. In addition to the relevant functions/functionality defined in [TS23501] (and/or discussed herein), if the UE 402 is in coverage, the N1 interface/reference point may be also used to convey the SLPR policy (SLPRP) (e.g., including service authorization) from the AMF 444 to the UE 402, and to convey the UE's 402 capability from the UE 402 to the AMF 444. If the LMF 470 supports SLPR-based services, it may be also used to carry the signaling between UE and LMF 470, as defined in [TS23273]. In addition to the relevant functions/functionality defined in [TS23501] (and/or discussed herein) for the N2 interface/reference point, in the case of SLPR-based service is supported by NG-RAN 404, the N2 interface/reference point is also used to convey the SLPRP and parameters (e.g., including service authorization) from the AMF 444 to the NG-RAN 404. The Uu interface/reference point is between individual UEs 402 and the NG-RAN 404. In addition to the relevant functions defined in [TS23273] (and/or discussed herein) for the NL10 interface/reference point, in the case of RSP service, it used by LMF 470 to get the location of located UE 402l and/or reference UE 402 from GMLC 472 using the application layer ID.

Additionally, the SLPR-based services are with the following service-based interfaces: In addition to the relevant services defined in [TS23273] (and/or discussed herein), if the LMF 470 supports SLPR-based service, the Nlmf interface may be used to provide service to other NFs related to it. In addition to the relevant services defined in [TS23501] (and/or discussed herein) for the Nudm interface, in the case of SLPR-based service, services provided by UDM 458 are used to get the related subscription information to AMF 444 during initial registration procedure and/or UE configuration update (UCU) procedure to inform AMF 444 subscription information has changed. In addition to the relevant services defined in [TS23501] (and/or discussed herein) for the Npcf interface, in the case of SLPR-based service, services provided by a home PCF 456 (H-PCF) are used to provide SLPR service-related parameters to a visiting PCF 456 (V-PCF) for UE 402 and NG-RAN 404 in roaming scenarios. In addition to the relevant services defined in [TS23501] (and/or discussed herein) for the Nudr interface, in the case of SLPR-based service, services provided by UDR 459 are used to notify the PCF 456 and the UDM 458 of the update of the SLPR-based service related information. In addition to the relevant services defined in [TS23501] (and/or discussed herein) for the Namf interface, in the case of SLPR-based service, services provided by AMF 444 are consumed by PCF 456 to provide the SLPR-based service related parameters for the UE 402 and the NG-RAN 404 to AMF 444, and to enable the AMF 444 create or update UE context related to SLPR-based service. In addition to the relevant services defined in [TS23501] (and/or discussed herein) for the Nnef interface, in the case of RSP service, services provided by the NEF 452 are used by the app server 438/yx98 to update RSP service related information of 5GC 440. In addition to the relevant services defined in [TS23501] (and/or discussed herein) for the Nnrf interface, in the case of RSP service, services provided by the NRF 454 are used to discover the PCF 456 that supports RSP.

In the example of FIG. 7, the DN 436 includes an SLPR server 498, and the UE 402-1 and UE 402-2 that are involved in SLPR-based services 492 have subscription from the same PLMN. The reference architecture 700 also supports the case that UE 402-1 and/or UE 402-2 are not registered to the NW or not in coverage. UE 402-3 and UE 402-4 may be out of coverage, or with partial network coverage. For simplicity, FIG. 7 only shows a target UE 402t and reference UEs (e.g., UE 402-1, UE 402-2, UE 402-3, and UE 402-4), and there could also be an assistant UE 402, located UE 402l, and SL positioning server UE 402. Other 5GC entities not marked with the SLPR label may still need to be involved in SLPR 492/yx98.

The target UE 402t may perform discovery procedure to detect any candidate anchor UEs 402a in its vicinity. This discovery procedure may entirely rely on the legacy SL PC5 discovery procedure [TS23287], 3GPP TS 23.304 (“[TS23304]”), which is handled above the AS layer. Both model A and Model B discovery can be applicable in this case. Additionally or alternatively, the PC5 discovery procedure may be enhanced to include specific information within the discovery message that aids the support of SL positioning.

In addition to the functions defined in [TS23287] and [TS23304], any of the UEs 402 discussed herein may support the following functions: reporting the following RSP capabilities to 5GC over the N1 reference point: capability of supporting RSP over PC5 (based on RSP control, a UE capable of RSP may take different roles in the operation, e.g. Target UE, SL Reference UE, Located UE) and capability of supporting SL positioning server UE 402 over PC5; procedures for RSP over PC5; procedures to NW-based SL positioning, and network assisted SL positioning; procedures to UE-only SL positioning; procedures for RSP service exposure; indicating UE policy provisioning request in UE policy container for UE triggered RSP policy provisioning, which requests one or multiple types of policies/parameters, such as policy/parameters for RSP over PC5, policy/parameters for located UE 402l, policy/parameters for target UE 402t in addition to the functions defined in [TS23273] § 4.3.5, policy/parameters for SL positioning client UE 402, and/or policy/parameters for SL positioning server UE 402; receiving RSP policies from the 5GC 440 over the N1 reference point; and configuration of parameters for RSP over the PC5 interface (these parameters can be pre-configured in the UE 402, or, if in coverage, provisioned or updated by signaling over the N1 reference point from the PCF 456 in the HPLMN or over SR1 reference point from the RSP application server 438/yx98).

An RSP service can be exposed to an authorized SL positioning client UE 402, a 5GC NF, or an AF 460 to obtain the relative position or distance/direction result (or location results) between two or more UEs 402 capable of RSP. RSP services can also be used by the authorized SL positioning client UE 402, 5GC NF, AF 402, or the LCS client 480 to obtain the absolute position of a target UE 402t if the 5GC NF, AF 402, or the LCS client 480 determines that RSP is applicable.

In the examples of FIG. 6, the target UE 402t may support positioning according to four different modes, including: UE assisted mode (e.g., the UE obtains location measurements and sends the measurements to another entity (e.g., an LMF 470) to compute a location); UE based mode (e.g., the UE obtains location measurements and computes a location estimate making use of assistance data provided by serving PLMN); standalone mode (e.g., the UE obtains location measurements and computes a location estimate without making use of assistance data provided by serving PLMN); and network based mode (e.g., a serving PLMN obtains location measurements of signals transmitted by a target UE 402t and computes a location estimate). The transmission of UE signals for network based mode may or may not be transparent to the UE 402.

Positioning procedures/methods used by a UE 402 for NG-RAN access are described in [TS38305]. A limited set of UE positioning capabilities and UE user plane positioning capabilities can be transferred to the 5GC 440 during registration of the UE 402 as described in 3GPP TS 24.501 (“[TS24501]”). Some of these positioning capabilities may be transferred subsequently to the LMF 470 as described in 3GPP TS 29.572 (“[TS29572]”). UE positioning capabilities may also be transferred directly to a location server (e.g., LMF 470).

Additional functions that may be supported by a UE 402 to support location services include one or more of the following functions: support location requests received from a network for 5GC-MT-LR, 5GC-NI-LR or a deferred 5GC-MT-LR for periodic or triggered location; support location requests to a network for a 5GC-MO-LR; support privacy notification and verification for a 5GC-MT-LR or deferred 5GC-MT-LR for periodic or triggered location; sending updated privacy requirements to a serving AMF 444 (for transfer to a UDR 459 via UDM 458); support periodic or triggered location reporting to an LMF 470; support change of a serving LMF 470 for periodic or triggered location reporting; support cancelation of periodic or triggered location reporting; support multiple simultaneous location sessions; support the reception of unciphered and/or ciphered assistance data broadcast by NG-RAN; support the reception of ciphering keys for the assistance data from the AMF 444; support handling of 5GC-MT-LR, 5GC-NI-LR, 5GC-MO-LR and deferred 5GC-MT-LR for periodic or triggered location over a user plane connection between UE and LMF 470; and/or support reporting of location events for a periodic or triggered 5GC-MT-LR over a user plane connection to an LCS Client 480 or AF 460 with periodic cumulative event reports being sent over control plane to the LMF 470, H-GMLC 472 and LCS Client 480 or AF 460.

A UE 402 may support the functions of a PRU 402p. In addition to the functions discussed herein and/or defined [TS38305], a PRU 402p supports the following functions including: support service level association, association update and disassociation with a serving LMF 470; the PRU 402p sends service level association, association update or disassociation to LMF via LCS supplementary service message; support association with multiple LMFs 470 (e.g., for the case a PRU is in multiple LMF overlapped serving areas). The PRU information included in a PRU association or PRU association update contains one or more than one of the following aspects: PRU Positioning Capabilities, and/or location information if known. a PRU disassociation is refers to a process of removing the PRU related information to dis-associate a PRU 402p with/from an LMF 470.

The Le reference point supports location requests sent by an LCS Client to a GMLC 472 or LRF 474. The Le reference point may be supported using the Mobile Location Protocol (MLP) defined by OMA. The NL3 reference point supports location requests forwarded by an HGMLC 472 to a VGMLC 472.

The N1 reference point supports transfer of supplementary services messages between a serving AMF 444 and target UE 402t to support privacy notification and verification and change of UE privacy preference. The N1 reference point also supports transfer of positioning protocol messages and location event reports between a target UE 402t and an LMF 470 via a serving AMF 444. The N1 reference point supports the transfer of ciphering keys from an AMF 444 to a suitably subscribed UE to enable the UE to receive ciphered broadcast assistance data. All messages sent over the N1 reference point for support of location services are encapsulated in NAS Transport messages as defined in [TS24501].

The N2 reference point supports transfer of positioning messages, via an AMF 444, between an LMF 470 and a RAN node, or N3IWF in the case of untrusted non-3GPP access. The N2 reference point also supports transfer of messages, via an AMF 444, from an LMF 470 to an NG-RAN node, which carry assistance data to be broadcast by the NG-RAN node. Positioning messages relevant to the N2 interface are defined in 3GPP TS 38.455.

The NL5 reference point supports location requests sent by an NEF 452 and/or other NF to a GMLC 472. The NL2 reference point supports location requests sent by a GMLC 472 to a serving AMF 444 for a target UE 402t. Messages for the NL2 reference point are defined in 3GPP TS 29.518 (“[TS29518]”). The NL6 reference point supports queries from an HGMLC 472 to a UDM 458 for privacy subscription information for a target UE 402t and routing information for a target UE 402t. The N51 reference point supports queries from an NEF 452 to a serving AMF 444 for the location of a target UE 402t. Messages for the N51 reference point are defined in [TS29518].

The NL1 reference point supports location requests for a target UE 402t sent from a serving AMF 444 for the target UE 402t to an LMF 470. Location requests are supported for immediate location and for deferred location for periodic or triggered location events. The NL1 reference point also supports the transfer from an LMF 470 to an AMF 444 of ciphering keys and associated data that enable deciphering by suitably subscribed UEs of ciphered broadcast assistance data. Messages for the NL1 reference point are defined in in [TS29518] and [TS29572].

The N52 reference point supports queries from an NEF 452 to a UDM 458 for privacy subscription information for a target UE 402t and routing information for a target UE 402t. The N52 interface also supports a request from an NEF 452 to a UDM 458 to forward a location request from the NEF 452 to a serving AMF 444 for the target UE 402t.

The NL7 reference point supports location context transfer between two LMFs 470. The NL8 reference point supports LMF 470 to receive location related analytics from NWDAF as defined in 3GPP TS 23.288. The NL9 reference point supports location requests sent by NWDAF to a GMLC 472.

In addition, the 5GS LCS architecture 600B may contain the following service-based interfaces for LCS: Nlmf (e.g., a service-based interface exhibited by the LMF 470) and Ngmlc (e.g., a service-based interface exhibited by the GMLC 472).

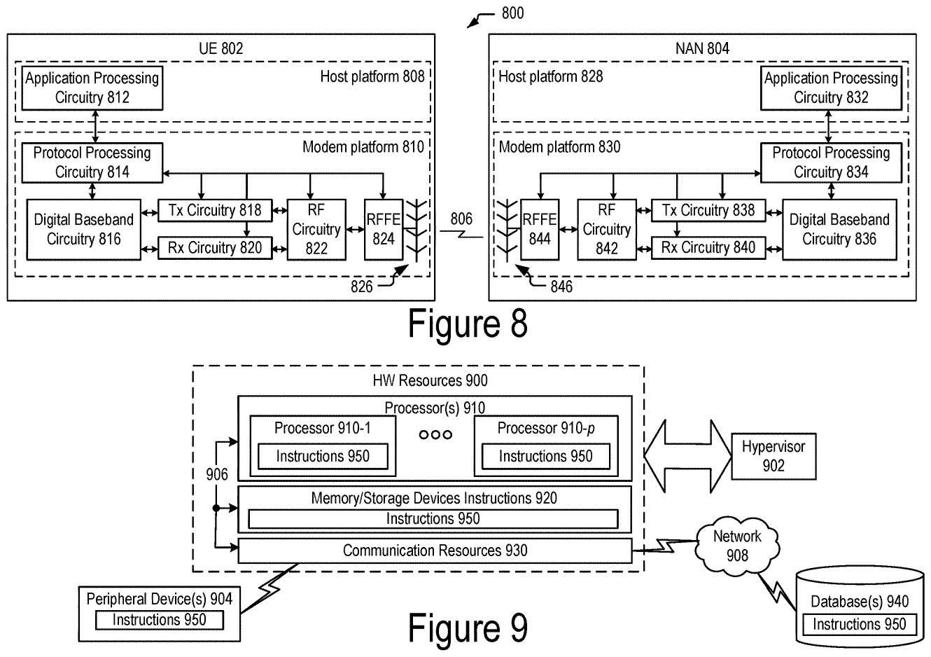

FIG. 8 illustrates a wireless network 800, which includes a UE 802 in wireless communication with a NAN 804. The UE 802 may be the same or similar to, and substantially interchangeable with any of the of the UEs discussed herein such as, for example, UE 402, hardware resources 800, and/or the like. The NAN 804 may be the same or similar to, and substantially interchangeable with any of the NANs discussed herein such as, for example, AP 406, NANs 414, RAN 404, hardware resources 900, and/or the like.

The UE 802 can communicatively couple with the NAN 804 via connection 806. The connection 506 is an air interface to enable communicative coupling, and can be consistent with cellular communications protocols (e.g., LTE, 5G/NR, mmWave or sub-6 GHZ frequencies, and/or any other access network protocol). The connection 806 may correspond to the Uu interface described with respect to (w.r.t) FIG. 4.

The UE 802 includes a host platform 808 coupled with a modem platform 810. The host platform 808 includes application processing circuitry 812, which may be coupled with protocol processing circuitry 814 of the modem platform 810. The application processing circuitry 812 may run various applications for the UE 802 that source/sink application data. The application processing circuitry 812 may further implement one or more layer operations to transmit/receive application data to/from a data network. These layer operations includes transport (e.g., user datagram protocol (UDP), QUIC (Quick UDP Internet Connections), transmission control protocol (TCP), GPRS Tunneling (GTP), and/or some other transport layer protocol) operations and network/Internet (e.g., internet protocol (IP), IPSec, routing information protocol (RIP), external gateway protocol (EGP), internet control message protocol (ICMP), internet group management protocol (IGMP), and/or some other network and/or Internet layer protocol) operations. The protocol processing circuitry 814 may perform one or more protocol layer operations to facilitate transmission or reception of data over the connection 806. The protocol layer operations implemented by the protocol processing circuitry 814 includes, for example, operations for some or all of the following layers: physical layer (PHY) (see e.g., 3GPP TS 38.201), medium access control (MAC) (see e.g., 3GPP TS 38.321), radio link control layer (RLC) (see e.g., 3GPP TS 38.322), packet data convergence protocol (PDCP) (see e.g., 3GPP TS 38.323), Service Data Adaptation Protocol (SDAP) (see e.g., 3GPP TS 37.324), radio resource control (RRC) (see e.g., 3GPP TS 38.331 (“[TS38331]”), and non-access stratum (NAS) (see e.g., 3GPP TS 24.301 and/or 3GPP TS 24.501).

The modem platform 810 may further include digital baseband circuitry 816 that may implement one or more layer operations that are “below” layer operations performed by the protocol processing circuitry 814 in a network protocol stack. These operations includes, for example, PHY operations including one or more of HARQ functions, scrambling/descrambling, encoding/decoding, layer mapping/de-mapping, modulation symbol mapping, received symbol/bit metric determination, multi-antenna port precoding/decoding, which includes one or more of space-time, space-frequency or spatial coding, reference signal generation/detection, preamble sequence generation and/or decoding, synchronization sequence generation/detection, control channel signal blind decoding, and/or other related functions, including any of those discussed herein and/or in 3GPP TS 36.201, 3GPP TS 38.201, [TS38211], [TS38212], [TS38213], [TS38214], and/or any other standards/specifications, including any of those mentioned herein. In some examples, the protocol processing circuitry 814 includes one or more instances of control circuitry (not shown) to provide control functions for the transmit/receive components.

The modem platform 810 may further include transmit circuitry 818, receive circuitry 820, RF circuitry 822, and RF front end (RFFE) 824, which includes or connect to one or more antenna panels 826. Briefly, the transmit circuitry 818 includes a digital-to-analog converter, mixer, intermediate frequency (IF) components, and/or the like; the receive circuitry 820 includes an analog-to-digital converter, mixer, IF components, and/or the like; the RF circuitry 822 includes a low-noise amplifier, a power amplifier, power tracking components, and/or the like; RFFE 824 includes filters (e.g., surface/bulk acoustic wave filters), switches, antenna tuners, beamforming components (e.g., phase-array antenna components), and/or the like The selection and arrangement of the components of the transmit circuitry 818, receive circuitry 820, RF circuitry 822, RFFE 824, and antenna panels 826 (referred generically as “transmit/receive components” or “Tx/Rx components”) may be specific to details of a specific implementation such as, for example, whether communication is TDM or FDM, in mmWave or sub-6 gHz frequencies, and/or the like. In some examples, the transmit/receive components may be arranged in multiple parallel Tx/Rx chains, may be disposed in the same or different chips/modules, and/or the like.

A UE reception may be established by and via the antenna panels 826, RFFE 824, RF circuitry 822, receive circuitry 820, digital baseband circuitry 816, and protocol processing circuitry 814. In some examples, the antenna panels 826 may receive a transmission from the NAN 804 by receive-beamforming signals received by a set of antennas/antenna elements of the one or more antenna panels 826. A UE transmission may be established by and via the protocol processing circuitry 814, digital baseband circuitry 816, transmit circuitry 818, RF circuitry 822, RFFE 824, and antenna panels 826. In some examples, the transmit components of the UE 804 may apply a spatial filter to the data to be transmitted to form a transmit beam emitted by the antenna elements of the antenna panels 826.

Similar to the UE 802, the NAN 804 includes a host platform 828 coupled with a modem platform 830. The host platform 828 includes application processing circuitry 832 coupled with protocol processing circuitry 834 of the modem platform 830. The modem platform may further include digital baseband circuitry 836, transmit circuitry 838, receive circuitry 840, RF circuitry 842, RFFE circuitry 844, and antenna panels 846. The components of the NAN 804 may be similar to and substantially interchangeable with like-named components of the UE 802. In addition to performing data transmission/reception as described above, the components of the NAN 804 may perform various logical functions that include, for example, RNC functions such as radio bearer management, UL and DL dynamic radio resource management, and data packet scheduling. Examples of the antenna elements of the antenna panels 826 and/or the antenna elements of the antenna panels 846 include planar inverted-F antennas (PIFAs), monopole antennas, dipole antennas, loop antennas, patch antennas, Yagi antennas, parabolic dish antennas, omni-directional antennas, and/or the like.

FIG. 9 illustrates components capable of reading instructions from a machine-readable or computer-readable medium (e.g., a non-transitory machine-readable storage medium) and perform any one or more of the methodologies discussed herein. Specifically, FIG. 9 shows hardware resources 900 including one or more processors (or processor cores) 910, one or more memory/storage devices 920, and one or more communication resources 930, each of which may be communicatively coupled via a bus 940 or other interface circuitry. For examples where node virtualization (e.g., NFV) is utilized, a hypervisor 902 may be executed to provide an execution environment for one or more network slices/sub-slices to utilize the hardware resources 900. In some examples, the hardware resources 900 may be implemented in or by an individual compute node, which may be housed in an enclosure of various form factors. In other examples, the hardware resources 900 may be implemented by multiple compute nodes that may be deployed in one or more data centers and/or distributed across one or more geographic regions. The processors 910 may include processors (or cores) 910-1 to 910-p (where p is a number). Individual processors 910-1 to 910-p may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), a microprocessor or controller, a multi-core processor, a multithreaded processor, an ultra-low voltage processor, an embedded processor, an xPU, a data processing unit (DPU), an Infrastructure Processing Unit (IPU), a network processing unit (NPU), another processor (including any of those discussed herein), and/or any suitable combination thereof. Each processor (or core) 910-1 to 910-p may be the same as, or different from, each other processor (or core) 910-1 to 910-p.

The memory/storage devices 920 may include main memory, disk storage, or any suitable combination thereof. The memory/storage devices 920 may include, but are not limited to, any type of volatile, non-volatile, semi-volatile memory, and/or any combination thereof. As examples, the memory/storage devices 920 can be or include random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, dual inline memory modules (DIMMs), microDIMMs, MiniDIMMs, block addressable memory device(s) (e.g., those based on NAND or NOR technologies), read-only memory (ROM), programmable ROM (PROM), erasable PROM (EPROM), electrically EPROM (EEPROM), flash memory, non-volatile RAM (NVRAM), solid-state storage, magnetic disk storage mediums, optical storage mediums, memory devices that use chalcogenide glass, multi-threshold level NAND flash memory, NOR flash memory, single or multi-level Phase Change Memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, and/or a combination of any of the aforementioned memory devices, and/or other memory.

The communication resources 930 may include interconnection or network interface controllers, components, or other suitable devices to communicate with one or more peripheral devices 904 or one or more databases 906 or other network elements via a network 908. For example, the communication resources 930 may include wired communication components (e.g., for coupling via USB, Ethernet, and/or the like), cellular communication components, NFC components, Bluetooth® components, WiFi® components, and other communication components.

Instructions 950 may comprise software, a program, an application, an applet, an app, or other executable code for causing at least any of the processors 910 to perform any one or more of the methodologies discussed herein. The instructions 950 may reside, completely or partially, within at least one of the processors 910 (e.g., within the processor's 910 cache memory), the memory/storage devices 920, or any suitable combination thereof. Furthermore, any portion of the instructions 950 may be transferred to the hardware resources 900 from any combination of the peripheral devices 904 or the databases 906. Accordingly, the memory of processors 910, the memory/storage devices 920, the peripheral devices 904, and the databases 906 are examples of computer-readable and machine-readable media.

In some examples, the peripheral devices 904 may represent one or more sensors such as, for example, exteroceptive sensors, proprioceptive sensors, and/or exproprioceptive sensors (e.g., sensors that capture, measure, or correlate internal states and external states). Examples of such sensors include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors/thermistors; pressure sensors; barometric pressure sensors; gravimeters; altimeters; image sensors/cameras; light detection and ranging (LiDAR) sensors; proximity sensors; depth sensors, ambient light sensors; optical light sensors; ultrasonic transceivers; microphones; power, energy, environmental (PEE) sensor(s); gas sensors; and the like.

Additionally or alternatively, the peripheral devices 404 may represent one or more actuators such as, for example, soft actuators (e.g., actuators that changes its shape in response to a stimuli such as, for example, mechanical, thermal, magnetic, and/or electrical stimuli), hydraulic actuators, pneumatic actuators, mechanical actuators, electromechanical actuators (EMAs), microelectromechanical actuators, electrohydraulic actuators, linear actuators, linear motors, rotary motors, DC motors, stepper motors, servomechanisms, electromechanical switches, electromechanical relays (EMRs), power switches, valve actuators, piezoelectric actuators and/or biomorphs, thermal biomorphs, solid state actuators, solid state relays (SSRs), shape-memory alloy-based actuators, electroactive polymer-based actuators, relay driver integrated circuits (ICs), solenoids, impactive actuators/mechanisms (e.g., jaws, claws, tweezers, clamps, hooks, mechanical fingers, humaniform dexterous robotic hands, and/or other gripper mechanisms that physically grasp by direct impact upon an object), propulsion actuators/mechanisms (e.g., wheels, axles, thrusters, propellers, engines, motors (e.g., those discussed previously), clutches, and the like), projectile actuators/mechanisms (e.g., mechanisms that shoot or propel objects or elements), and/or audible sound generators, visual warning devices, and/or other like electromechanical components.

### 3. Example Implementations

FIG. 11 shows an example process 1100 to be performed by a target UE 402t. The process 1100 includes, at operation 1101, the target UE 402t receives an SLPP request to measure and report SL positioning measurements. At operation 1102, the target UE 402t measures a set of SL PRSs based on the received request; At operation 1103, the target UE 402t transmits a measurement report, wherein the measurement report includes positioning results based on the measurement of the set of SL PRSs.

The example operations of process 1000 and 1100 can be arranged in different orders, one or more of the depicted operations may be combined and/or divided/split into multiple operations, depicted operations may be omitted, and/or additional or alternative operations may be included in any of the depicted processes. Additional examples of the presently described methods, devices, systems, and networks discussed herein include the following, non-limiting example implementations.

Each of the following non-limiting examples may stand on its own or may be combined in any permutation or combination with any one or more of the other examples provided below or throughout the present disclosure.

Example A01 includes a method, comprising: defining UE behavior and requirements when a UE performs positioning measurements in sidelink (SL).

Example A02 includes the method of example A01 and/or some other example(s) herein, wherein the positioning measurements can be for round trip time (RTT) and Time Difference of Arrival (TDoA) with new SL-Positioning Reference Signal (PRS).

Example A03 includes the method of examples A01-A02 and/or some other example(s) herein, wherein the requirements can be defined for both PC5-only and/or PC5-Uu joint scenarios.

Example A04 includes the method of example A03 and/or some other example(s) herein, wherein the requirements for PC5-Uu joint scenario can be defined based on PC5-only and Uu-only.

Example A05 includes the method of examples A01-A04 and/or some other example(s) herein, wherein a report mapping for power control of SL-PRS can be defined.

Example A06 includes the method of examples A01-A04 and/or some other example(s) herein, wherein a report mapping for measured timing differences between reference signals of SL-PRS can be defined.

Example A07 includes the method of examples A01-A06 and/or some other example(s) herein, wherein the method is performed by a user equipment (UE).

Example B01 includes a method of operating a target user equipment (UE), the method comprising: receiving a sidelink positioning protocol (SLPP) request to measure and report sidelink (SL) positioning measurements; measuring a set of SL positioning reference signals (PRSs) based on the received request; and transmitting a measurement report, wherein the measurement report includes positioning results based on the measurement of the set of SL PRSs.

Example B02 includes the method of example B01 and/or some other example(s) herein, wherein, when the UE is capable of performing SL time difference of arrival (TDoA) positioning, the measuring includes: performing an SL reference signal time difference (RSTD) measurement according to a set of accuracy requirements and during a measurement period, wherein the SL RSTD measurement includes measurement of a first SL PRS in the set of SL PRSs from a first peer UE on a target link and measurement of a second SL PRS in the set of SL PRSs from a second peer UE on reference link.

Example B03 includes the method of example B02 and/or some other example(s) herein, wherein the method includes: determining a position of the target UE relative to a first location of the first peer UE and a second location of the second peer UE.

Example B04 includes the method of example B03 and/or some other example(s) herein, wherein the determining includes: estimating the position of the target UE based on the SL RSTD measurement, knowledge of geographical coordinates of the first peer UE and the second peer UE, and a relative SL timing of the first SL PRS and the second SL PRS.

Example B05 includes the method of examples B02-B04 and/or some other example(s) herein, wherein the method includes. generating the measurement report to include SL RSTD measurement values of the SL RSTD measurement based on measurement report mapping requirements.

Example B06 includes the method of examples B02-B05 and/or some other example(s) herein, wherein the target link includes a PC5 interface, and reference link includes a PC5 interface or a Uu interface.

Example B07 includes the method of examples B02-6 and/or some other example(s) herein, wherein the measurement of the first SL PRS is a first SL PRS-reference signal received power (RSRP) measurement and the measurement of the second SL PRS is a second SL PRS-RSRP measurement.

Example B08 includes the method of example B01 and/or some other example(s) herein, wherein, when the UE is capable of performing SL TDoA positioning or SL round trip time (RTT) positioning, and the measuring includes: performing a SL reception (Rx)-transmission (Tx) time difference measurement according to a set of accuracy requirements and during a measurement period, wherein the SL Rx-Tx time difference measurement is based on measurement of SL PRS in the set of SL PRSs transmitted by a peer UE.

Example B09 includes the method of example B08 and/or some other example(s) herein, wherein the method includes: determining an SL RTT measurement based on the performed SL Rx-Tx time difference measurement and another SL Rx-Tx time difference measurement performed at the peer UEs based on SL signals transmitted by the target UE.

Example B10 includes the method of examples B08-B09 and/or some other example(s) herein, wherein the method includes. generating the measurement report to include SL RTT measurement values of the SL RTT measurement based on measurement report mapping requirements.

Example B11 includes the method of examples B09-10 and/or some other example(s) herein, wherein the measurement of the SL PRS in the set of SL PRSs transmitted by the peer UE is an SL PRS-RSRP measurement.

Example B12 includes the method of example B01 and/or some other example(s) herein, wherein, when the UE is capable of performing SL TDoA positioning, SL RTT positioning, SL angle of arrival (AoA) positioning, or SL time of arrival (TOA) positioning, and the measuring includes: performing an SL PRS-RSRP measurement according to a set of accuracy requirements and during a measurement period, wherein the SL PRS-RSRP measurement is a linear average of one or more resource elements that carry at least one SL PRS in the set of SL PRSs configured for RSRP measurements within a considered measurement frequency bandwidth.

Example B13 includes the method of examples B01-B12 and/or some other example(s) herein, wherein the SLPP request is an SLPP request location information message or an SLPP provide assistance data message.

Example B14 includes the method of examples B01-B13 and/or some other example(s) herein, wherein the measurement report is included in an SLPP provide location information message.

Example B15 includes the method of examples B01-B14 and/or some other example(s) herein, wherein the measurement report mapping requirements include mapping requirements for power control of the set of SL PRSs.

Example B16 includes the method of examples B01-B14 and/or some other example(s) herein, wherein the measurement report mapping requirements include mapping requirements for measured timing differences between reference signals of SL-PRS.

Example B17 includes the method of examples B01-B16 and/or some other example(s) herein, wherein the receiving includes: receiving the SLPP request from a location management function (LMF) or another UE.

Example Z01 includes one or more computer readable media comprising instructions, wherein execution of the instructions by processor circuitry is to cause the processor circuitry to perform the method of any one of examples A01-A07, B01-B17. Example Z02 includes a computer program comprising the instructions of example Z01. Example Z03 includes an Application Programming Interface defining functions, methods, variables, data structures, and/or protocols for the computer program of example Z02. Example Z04 includes an API or specification defining functions, methods, variables, data structures, protocols, and the like, defining or involving use of any of examples A01-A07, B01-B17 or portions thereof, or otherwise related to any of examples A01-A07, B01-B17 or portions thereof. Example Z05 includes an apparatus comprising circuitry loaded with the instructions of example Z01. Example Z06 includes an apparatus comprising circuitry operable to run the instructions of example Z01. Example Z07 includes an integrated circuit comprising one or more of the processor circuitry of example Z01 and the one or more computer readable media of example Z01. Example Z08 includes a computing system comprising the one or more computer readable media and the processor circuitry of example Z01. Example Z09 includes an apparatus comprising means for executing the instructions of example Z01. Example Z10 includes a signal generated as a result of executing the instructions of example Z01. Example Z11 includes a data unit generated as a result of executing the instructions of example Z01. Example Z12 includes the data unit of example Z10 and/or some other example(s) herein, wherein the data unit is a datagram, network packet, data frame, data segment, a Protocol Data Unit (PDU), a Service Data Unit (SDU), a message, or a database object. Example Z13 includes a signal encoded with the data unit of examples Z11 and/or Z12. Example Z14 includes an electromagnetic signal carrying the instructions of example Z01.

Example Z15 includes an apparatus comprising means for performing the method of any one of examples A01-A07, B01-B17 and/or some other example(s) herein. Example Z16 includes a compute node executing a service as part of one or more applications instantiated on virtualization infrastructure, the service being related to any of examples 4Z, portions thereof, and/or some other example(s) herein. Example Z17 includes a method of communicating in a wireless network as shown and described herein. Example Z18 includes a system for providing wireless communication as shown and described herein. Example Z19 includes a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### 4. Terminology

For the purposes of the present document, the following terms and definitions are applicable to the examples and embodiments discussed herein. Additionally, the terminology discussed in '719, [TS38133], [TS38215], [TR38857], [TR38845], [TS22261], [TS22104], [TS38355], [TS38305], [TS38859], and 3GPP TS 21.905 may also be applicable to the examples and embodiments discussed herein.

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, epochs, iterations, stages, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The phrase “X(s)” means one or more X or a set of X. The description may use the phrases “in an embodiment,” “In some embodiments,” “in one implementation,” “In some implementations,” “in some examples”, and the like, each of which may refer to one or more of the same or different embodiments, implementations, and/or examples. Furthermore, the terms “comprising,” “including,” “having,” and the like, as used with respect to the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “absolute position” at least in some examples refers to an estimate of the UE position in 2D/3D geographic coordinates (e.g., latitude, longitude, elevation) within a coordinate system.

The term “access technology” at least in some examples refers to the technology used for the underlying physical connection to a communication network. The term “radio access technology” or “RAT” at least in some examples refers to the technology used for the underlying physical connection to a radio based communication network. The term “radio technology” at least in some examples refers to technology for wireless transmission and/or reception of electromagnetic radiation for information transfer. The term “RAT type” at least in some examples may identify a transmission technology and/or communication protocol used in an access network. Examples of access technologies are discussed in '719.

The term “alert limit” or “AL” at least in some examples refers to the maximum allowable positioning error for the purpose of integrity. Additionally or alternatively, the term “alert limit” or “AL” at least in some examples refers to the maximum allowable positioning error such that the positioning system is available for the intended application. In some examples, if the positioning error is beyond the AL, the integrity results of the calculated location may not meet the integrity requirements. Additionally or alternatively, if the positioning error is beyond the AL, the positioning system may be declared unavailable for the intended application to prevent loss of positioning integrity. Additionally or alternatively, when the AL bounds the positioning error in the horizontal plane or on the vertical axis then it is called horizontal AL (HAL) or vertical AL (VAL), respectively.

The term “anchor UE” at least in some examples refers to a UE, supporting positioning of target UE, for example, by transmitting and/or receiving reference signals for positioning, providing positioning-related information, and/or the like over a sidelink interface.

The term “application layer ID” at least in some examples refers to an identifier identifying a RSP-enabled UE within the context of a specific application. The format of this identifier is outside the scope of 3GPP.

The term “direction” at least in some examples refers to a direction to the target UE from another UE, such as another target UE, a located UE or an SL reference UE. Additionally or alternatively, the term “direction” at least in some examples refers to a direction from a target UE to another UE, such as another target UE, a located UE or an SL reference UE.

The term “field” at least in some examples refers to the individual contents of an information element (IE).

The term “integrity availability” at least in some examples refers to the integrity availability is the percentage of time that the PL is below the required AL.

The term “located UE” at least in some examples refers to an SL reference UE of which the location is known or is able to be known using Uu based positioning. In some examples, a located UE can be used to determine the location of a target UE using SL positioning.

The term “measurement” at least in some examples refers to the observation and/or quantification of attributes of an object, event, or phenomenon. Additionally or alternatively, the term “measurement” at least in some examples refers to a set of operations having the object of determining a measured value or measurement result, and/or the actual instance or execution of operations leading to a measured value. Additionally or alternatively, the term “measurement” at least in some examples refers to data recorded during testing. The term “metric” at least in some examples refers to a quantity produced in an assessment of a measured value. Additionally or alternatively, the term “metric” at least in some examples refers to data derived from a set of measurements. Additionally or alternatively, the term “metric” at least in some examples refers to set of events combined or otherwise grouped into one or more values. Additionally or alternatively, the term “metric” at least in some examples refers to a combination of measures or set of collected data points. Additionally or alternatively, the term “metric” at least in some examples refers to a standard definition of a quantity, produced in an assessment of performance and/or reliability of the network, which has an intended utility and is carefully specified to convey the exact meaning of a measured value.

The term “mobile TRP” at least in some examples refers to a TRP belonging to a mobile IAB-node and/or a UE.

The term “pre-configured assistance data” at least in some examples refers to the downlink (DL)-positioning reference signal (PRS) assistance data (with associated validity criteria) that can be provided to a UE (before or during an ongoing positioning session) to be then utilized for potential positioning measurements at a future time (e.g., for deferred MT-LR). In some examples, “pre-configured assistance data” and/or pre-configured DL-PRS assistance data includes multiple instances, where each instance is applicable to a different area within the network.

The term “positioning” at least in some examples refers to a functionality that detects a geographical location and/or a velocity of an entity/element (e.g., UE and/or other device).

The term “positioning integrity” at least in some examples refers to a measure of the trust in the accuracy of the position-related data and the ability to provide associated alerts. Additionally or alternatively, the term “positioning integrity” at least in some examples refers to a measure of the trust in the accuracy of the position-related data provided by the positioning system and the ability to provide timely and valid warnings to an LCS client when the positioning system does not fulfil the condition for intended operation.

The term “positioning service availability” at least in some examples refers to a percentage value of the amount of time the positioning service is delivering the required position-related data within the performance requirements, divided by the amount of time the system is expected to deliver the positioning service according to the specification in the targeted service area.

The term “positioning service latency” at least in some examples refers to an amount of time elapsed between the event that triggers the determination of the position-related data and the availability of the position-related data at the system interface.

The term “protection level” or “PL” at least in some examples refers to a statistical upper-bound of the positioning error (PE) that ensures that the probability per unit of time of a true error being greater than the AL and the PL being less than or equal to the AL, for longer than the time-to-alert (TTA), is less than a target integrity risk (TIR).

The term “PRS-only transmission point” or “PRS-only TP” at least in some examples refers to a TP which only transmits PRS and/or DL-PRS signals, and is not associated with a cell.

The term “PRS processing window” or “PPW” at least in some examples refers to a processing window configured by the network to a UE for NR DL-PRS measurements without measurement gap.

The term “range” at least in some examples refers to a straight line distance between a target UE and another UE, such as another target UE, a located UE, or an SL reference UE.

The term “ranging” at least in some examples refers to the determination of the distance between two UEs (or more than two UEs) and/or the direction of one UE (e.g., a target UE) from another UE (e.g., an SL reference UE, an anchor UE, and/or the like) via PC5 interface. Additionally or alternatively, the term “ranging” at least in some examples refers to the determination of the distance and/or the direction between a UE and another entity (e.g., an anchor UE, an SL reference UE, and/or the like).

The term “ranging/sidelink positioning”, “ranging/SL positioning”, or “RSP” at least in some examples refers to access stratum (AS) functionality enabling ranging based services and sidelink positioning as specified in 3GPP TS 23.586 (“[TS23586]”).

The term “ranging/sidelink positioning protocol”, “ranging/SL positioning protocol”, “RSP protocol”, or “RSPP” at least in some examples refers to a protocol for providing RSP services. In some examples, RSPP comprises SLPP messages and Supplementary Services messages according to [TS23586].

The term “ranging/sidelink positioning application identifier”, “ranging/SL positioning application identifier”, or “RSP app ID” at least in some examples refers to a globally unique identifier (ID) identifying a specific RSP application, which can be mapped to a V2X service type or a ProSe ID.

The term “reception point” or “RP” at least in some examples refers to a set of geographically co-located receive antennas (e.g., antenna array (with one or more antenna elements)) for one cell, part of one cell or one UL-SRS-only RP. Reception Points can include base station (ng-eNB or gNB) antennas, remote radio heads, a remote antenna of a base station, an antenna of a UL-SRS-only RP, etc. One cell can include one or multiple reception points. For a homogeneous deployment, each reception point may correspond to one cell.

The term “relative location” at least in some examples refers to the location of a target UE relative to a network element or another UE. In some examples, the relative location can be in two dimensions or three dimensions. In some examples, location results that may be obtained for a target UE are summarized and/or defined in more detail in [TS23032] and/or [TS23586]. The term “relative position” at least in some examples refers to a position (or an estimate of a UE position) relative to other network elements and/or relative to other UEs.

The term “relative velocity” at least in some examples refers to a velocity (or an estimate of a UE velocity) relative to a network element, another UE, and/or some other object. In some examples, a relative velocity of a target UE includes a radial component equal to a rate of change of a range between the target UE and the other UE and a transverse component at right angles to the radial component.

The term “reception time delay” or “Rx time delay” at least in some examples refers to, from a signal reception perspective, a time delay from the time when a radiofrequency (RF) signal arrives at the Rx antenna to the time when the signal is digitized and time-stamped at the baseband.

The term “reception timing error” or “Rx timing error” at least in some examples refers to result(s) of Rx time delay involved in the reception of a signal before reporting measurements that are obtained from the signal. In some examples, the Rx timing error is the uncalibrated Rx time delay, or the remaining delay after the UE/TRP internal calibration/compensation of the Rx time delay, involved in the reception of the DL-PRS/UL SRS signals. Additionally or alternatively, the calibration/compensation may also include the calibration/compensation of the relative time delay between different RF chains in the same UE/TRP and may also possibly consider the offset of the Rx antenna phase centre to the physical antenna centre.

The term “sidelink positioning” or “SL positioning” at least in some examples refers to a functionality that determines a geographical location, absolute location, relative position, relative location, ranging information, and possibly velocity (e.g., absolute velocity and/or relative velocity), using sidelink measurements. Additionally or alternatively, the term “sidelink positioning” or “SL positioning” at least in some examples refers to a positioning UE using PC5 to obtain absolute position, relative position, and/or ranging information.

The term “sidelink anchor UE” or “SL anchor UE” at least in some examples refers to a UE supporting positioning of a target UE, for example, by transmitting and/or receiving reference signals for positioning, providing positioning-related information, and/or the like using sidelink.

The term “sidelink positioning client UE” or “SL positioning client UE” at least in some examples refers to a third-party UE, other than SL reference UE and target UE, that initiates RSP service request on behalf of the application residing on it. In some examples, the SL Positioning Client UE does not have to support RSP capability, but a communication between the SL Positioning Client UE and SL Reference UE/Target UE has to be established, either via PC5 or via 5GC, for the transmission of the service request and the result.

The term “sidelink positioning protocol”, “SL positioning protocol”, or “SLPP” at least in some examples refers to a protocol for sidelink positioning procedures.

The term “sidelink positioning reference signal” or “SL PRS” at least in some examples refers to a reference signal transmitted over sidelink for positioning purposes.

The term “sidelink positioning server UE” or “SL positioning server UE” at least in some examples refers to a UE offering method determination, assistant data distribution and/or location calculation functionalities for Sidelink Positioning and Ranging based service. It interacts with other UEs over PC5 as necessary in order to determine Ranging/SL Position method, distribute assistant data and calculate the location of the Target UE. In some examples, a target UE or SL reference UE can act as an SL positioning server UE if any of the functionalities is supported.

The term “sidelink reference UE” or “SL reference UE” at least in some examples refers to a UE supporting positioning of a target UE (e.g., by transmitting and/or receiving reference signals for positioning), providing positioning-related information, and/or the like using SL. In some examples, SL Reference UE may be referred to as an “anchor UE”.

The term “sidelink server UE” or “SL server UE” at least in some examples refers to a UE offering position method determination, assistance data distribution and/or location calculation functionalities for SL positioning and ranging based services. In some examples, a SL server UE interacts with other UEs over a PC5 interface in order to determine an RSP method, distribute assistance data, and calculate the location of the target UE. In some examples, a target UE and/or SL anchor UE can act as SL server UE if any of the functionalities is/are supported.

The term “sidelink target UE” or “SL target UE” at least in some examples refers to a UE whose distance, direction, and/or position is measured with the support from one or multiple SL anchor UEs using sidelink.

The term “SRS-only RP” at least in some examples refers to an RP that only receives UL-SRS signals and is not associated with a cell.

The term “target integrity risk” or “TIR” at least in some examples refers to the probability that the positioning error exceeds the AL without warning the user within the required TTA. In some examples, the TIR is usually defined as a probability rate per some time unit (e.g., per hour, per second or per independent sample).

The term “target UE” at least in some examples refers to a UE to be positioned, for example, using sidelink and/or a PC5 interface. Additionally or alternatively, the term “target UE” at least in some examples refers to a UE whose distance, direction, and/or position is measured with the support from one or multiple anchor UEs using sidelink in the ranging based service(s) and/or sidelink positioning.

The term “Time-to-Alert” or “TTA” at least in some examples refers to the maximum allowable elapsed time from when the positioning error exceeds the AL until the function providing positioning integrity annunciates a corresponding alert.

The term “transmission point” or “TP” at least in some examples refers to a set of geographically co-located transmit antennas (e.g., antenna array with one or more antenna elements) for one cell, part of one cell, and/or one DL-PRS-only TP. In some examples, TPs can include base station (e.g., ng-eNB or gNB) antennas, remote radio heads, a remote antenna of a base station, an antenna of a DL-PRS-only TP, and/or the like. Additionally or alternatively, one cell can include one or multiple TPs. Additionally or alternatively, for a homogeneous deployment, each TP may correspond to one cell.

The term “transmission reception point” or “TRP” at least in some examples refers to an antenna array with one or more antenna elements available to a network located at a specific geographical location for a specific area. Additionally or alternatively, the term “transmission reception point” or “TRP” at least in some examples refers to a set of geographically co-located antennas (e.g., an antenna array with one or more antenna elements) supporting TP and/or RP functionality.

The term “Tx time delay” at least in some examples refers to, from a signal transmission perspective, the time delay from the time when the digital signal is generated at baseband to the time when the RF signal is transmitted from the Tx antenna.

The term “Tx timing error” at least in some examples refers to a result of Tx time delay involved in the transmission of a signal. In some examples, the Tx timing error is the uncalibrated Tx time delay, or the remaining delay after the TRP/UE internal calibration/compensation of the Tx time delay, involved in the transmission of the DL-PRS/UL SRS signals. Additionally or alternatively, the calibration/compensation may also include the calibration/compensation of the relative time delay between different RF chains in the same TRP/UE and may also possibly consider the offset of the Tx antenna phase centre to the physical antenna center.

The term “UE-only operation” at least in some examples refers to operation of RSP in which the service request handling and result calculation are performed by a UE. In some examples, for UE-only Operation, the communication among UEs are over PC5.

The term “UE-to-Network Relay UE”, “U2N Relay UE”, or “U2NR” at least in some examples refers to a UE that provides functionality to support connectivity to the network for U2N Remote UE(s).

The term “UE-to-Network Remote UE”, “U2N Remote UE”, or “U2N RUE” at least in some examples refers to a UE that communicates with the network via a U2N Relay UE.

The term “user information identifier”, “user information identity”, or “user info ID” at least in some examples refers to an ID configured for RSP UE discovery based on the policy of the HPLMN or via the RSP application server that allocates it. In some examples, the definition of values of user info ID is predefined, configurable, and/or implementation-specific.

Although many of the examples discussed herein are provided with use of specific cellular/mobile network terminology, including with the use of 4G/5G 3GPP network components (or expected terahertz-based 6G/6G+ technologies), these examples may be applied to many other deployments of wide area and local wireless networks, as well as the integration of wired networks (including optical networks and associated fibers, transceivers, and/or the like). Furthermore, various standards (e.g, 3GPP, ETSI, IEEE, and/or the like) may define various message formats, PDUs, MAC CEs, containers, frames, and/or other data structures, as comprising a sequence of optional or mandatory containers, frames, data elements (DEs), data frames (DFs), information elements (IEs), information object classes (IOCs), managed object classes (MOCs), parameters, attributes, and/or other elements. However, the requirements of any particular standard should not limit the examples discussed herein, and as such, any combination of containers, frames, DFs, DEs, IEs, IOCs, MOCs, parameters, attributes, values, actions, features, and/or other elements are possible in various examples, including any combination of containers, frames, DFs, DEs, IEs, IOCs, MOCs, parameters, attributes, values, actions, features, and/or other elements that are strictly required to be followed in order to conform to such standards or any combination of containers, frames, DFs, DEs, IEs, IOCs, MOCs, parameters, attributes, values, actions, features, and/or other elements strongly recommended and/or used with or in the presence/absence of optional elements.

Moreover, the present disclosure provides various examples of names/labels for various systems, sub-systems, devices, planes, layers, protocols, components, operations, containers, frames, DFs, DEs, IEs, IOCs, MOCs, parameters, attributes, values, actions, features, and other elements/data structures. However, the specific names or labels used regarding the various systems, sub-systems, devices, planes, layers, components, operations, parameters, attributes, IEs, IOCs, MOCs, and other elements/data structures, are provided for the purpose of discussion and illustration, rather than limitation. The various systems, sub-systems, devices, planes, layers, components, operations, parameters, attributes, IEs, IOCs, MOCs, and other elements/data structures can have alternative names or labels to those provided herein. Furthermore, additional or alternative embodiments, implementations, and/or iterations of 3GPP specifications and/or other relevant standards/specifications may name certain elements/entities different to those discussed herein, but still fall within the context of the present disclosure.

Aspects of the inventive subject matter may be referred to herein, individually and/or collectively, merely for convenience and without intending to voluntarily limit the scope of this application to any single aspect or inventive concept. Although specific aspects have been shown and described herein, the present disclosure covers any and all adaptations or variations and any arrangement capable of achieving the same purpose may be substituted for the specific aspects shown and described herein. Combinations of the described aspects and other aspects not specifically described herein will be apparent to those of skill in the art upon reviewing the present disclosure.

1-45. (canceled)

46. A User Equipment (UE) configured for operation in a 5G NR network, the UE comprising: processing circuitry; and memory,
the UE capable of sidelink (SL) operation and performing SL positioning measurements,
wherein the processing circuitry is configured to:
receive a request message via a sidelink positioning protocol (SLPP) to measure and report results of SL positioning measurements based on SL positioning reference signals (SL-PRS);
wherein the SL positioning measurements include one or more of:
a SL Reference Signal Time Difference (SL RSTD) measurement,
a SL Positioning Reference Signal (PRS) Reference Signal Received Power (SL PRS RSRP) measurement,
a SL Receive-Transmit (Rx-Tx) time difference (SL Rx-Tx) measurement,
a SL PRS Reference Signal Received Path Power (SL PRS RSRPP) measurement,
a SL Angle of Arrival (AoA) (SL AoA) measurement, and
a SL Relative Time Of Arrival (SL RTOA) measurement,
measure the SL-PRS based on the request; and
transmit a measurement report that includes the results of the SL positioning measurements performed on the SL PRS.

47. The UE of claim 46, wherein the request message received via the SLPP to measure and report results of the SL positioning measurements is received from a location measurement function (LMF) of the network, and
wherein the measurement report is transmitted to the LMF.

48. The UE of claim 46, wherein the request message received via the SLPP to measure and report results of the SL positioning measurements is received from another UE, and
wherein the measurement report is transmitted to the other UE.

49. The UE of claim 48, wherein for performing SL time difference of arrival (TDoA) positioning, the processing circuitry is to configure the UE to:
perform the SL RSTD measurement for each SL-PRS resource according to accuracy requirements and during a measurement period.

50. The UE of claim 49, wherein the SL RSTD measurement includes measurement of a first SL-PRS from reference UE and a measurement of a second SL PRS from an anchor UE.

51. The UE of claim 50, wherein for performing the SL RSTD measurement, the measurement of the first SL-PRS is a first SL PRS reference signal received power (RSRP) measurement and the measurement of the second SL-PRS is a second SL PRS-RSRP measurement.

52. The UE of claim 51, wherein the SL PRS including the first and second SL-PRS, are received over a NR PC5 interface.

53. The UE of claim 52, wherein the UE is a target UE, and
wherein based on the SL positioning measurements, the processing circuitry is configured to determine a relative position of the target UE a location of the reference UE and a location of the anchor UE.

54. The UE of claim 52, wherein the UE is a target UE, and
wherein the processing circuitry is configured to estimate a position of the target UE based on the SL RSTD measurement, geographical coordinates of the reference UE and the anchor UE, and a relative SL timing of the first SL-PRS and the second SL-PRS.

55. The UE of claim 52, wherein the processing circuitry is to:
configure the UE to perform the SL Rx-Tx time difference measurement with the reference UE and the anchor UE, and
generate the measurement report to include results of a SL round trip time (SL RTT) measurement based on measurement report mapping requirements.

56. An apparatus of a User Equipment (UE) configured for operation in a 5G NR network, the UE capable of sidelink (SL) operation and performing SL positioning measurements, the apparatus comprising: processing circuitry; and memory, wherein the processing circuitry is configured to:
receive a request message via a sidelink positioning protocol (SLPP) to measure and report results of SL positioning measurements based on SL positioning reference signals (SL-PRS);
measure the SL-PRS based on the request; and
transmit a measurement report that includes the results of the SL positioning measurements performed on the SL-PRS,
wherein for performing SL time difference of arrival (TDoA) positioning, the processing circuitry is to configure the UE to perform a SL Reference Signal Time Difference (SL RSTD) measurement for each SL-PRS resource according to accuracy requirements and during a measurement period, and
wherein the SL RSTD measurement includes measurement of a first SL-PRS from reference UE and a measurement of a second SL-PRS from an anchor UE.

57. The apparatus of claim 56, wherein for performing the SL RSTD measurement, the measurement of the first SL-PRS is a first SL PRS reference signal received power (RSRP) measurement and the measurement of the second SL-PRS is a second SL PRS-RSRP measurement.

58. The apparatus of claim 57, wherein the processing circuitry is to:
configure the UE to perform a SL Receive-Transmit (Rx-Tx) time difference (SL Rx-Tx) measurement with the reference UE and the anchor UE, and
generate the measurement report to include results of a SL round trip time (SL RTT) measurement based on measurement report mapping requirements.

59. The apparatus of claim 58, wherein the request message received via the SLPP is a first request message to measure and report first results of the SL positioning measurements received from a location measurement function (LMF) of the network, and
wherein the measurement report is a first measurement report and is transmitted to the LMF.

60. The apparatus of claim 59, wherein the request message received via the SLPP is a second request message to measure and report results of the SL positioning measurements received from another UE, and
wherein the measurement report is a second measurement report and is transmitted to the other UE.

61. The apparatus of claim 60, wherein the UE is a target UE, and
wherein based on the SL positioning measurements, the processing circuitry is configured to determine a relative position of the target UE a location of the reference UE and a location of the anchor UE.

62. The apparatus of claim 60, wherein the UE is a target UE, and
wherein the processing circuitry is configured to estimate a position of the target UE based on the SL RSTD measurement, geographical coordinates of the reference UE and the anchor UE, and a relative SL timing of the first SL-PRS and the second SL-PRS.

63. A non-transitory computer-readable storage medium that stores instructions for execution by processing circuitry of User Equipment (UE) configured for operation in a 5G NR network, the UE capable of sidelink (SL) operation and performing SL positioning measurements, wherein the processing circuitry is configured to:
receive a request message via a sidelink positioning protocol (SLPP) to measure and report results of SL positioning measurements based on SL positioning reference signals (SL-PRS);
measure the SL-PRS based on the request; and
transmit a measurement report that includes the results of the SL positioning measurements performed on the SL-PRS,
wherein for performing SL time difference of arrival (TDoA) positioning, the processing circuitry is to configure the UE to perform a SL Reference Signal Time Difference (SL RSTD) measurement for each SL-PRS resource according to accuracy requirements and during a measurement period, and
wherein the SL RSTD measurement includes measurement of a first SL-PRS from reference UE and a measurement of a second SL-PRS from an anchor UE.

64. The non-transitory computer-readable storage medium of claim 63, wherein for performing the SL RSTD measurement, the measurement of the first SL-PRS is a first SL PRS reference signal received power (RSRP) measurement and the measurement of the second SL-PRS is a second SL PRS-RSRP measurement.

65. The non-transitory computer-readable storage medium of claim 64, wherein the processing circuitry is to:
configure the UE to perform a SL Receive-Transmit (Rx-Tx) time difference (SL Rx-Tx) measurement with the reference UE and the anchor UE, and
generate the measurement report to include results of a SL round trip time (SL RTT) measurement based on measurement report mapping requirements.
